(19) United States
(12) Patent Application Publication
(10) Pub. No.: US 2020/0090155 A1
(43) Pub. Date: Mar. 19, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/258,694

(22) Filed: Jan. 28, 2019

(30) Foreign Application Priority Data
Sep. 18, 2018 (JP) 2018-173381

(51) Int. Cl. G06Q 20/22; G06Q 20/36; G06Q 20/38; G06Q 20/20

(52) U.S. Cl. CPC G06Q 20/227; G06Q 20/204; G06Q 20/387; G06Q 20/363

(57) ABSTRACT

An information processing apparatus includes a reception unit that receives payment by a recommended payment method determined according to a determination criterion for determining the recommended payment method from among one or plural payment methods payable by a user, in a case of receiving a payment request from the user.

### CROSS-REFERENCE TO RELATED APPLICATIONS

This application is based on and claims priority under 35 USC 119 from Japanese Patent Application No. 2018-173381 filed Sep. 18, 2018.

### BACKGROUND

### (i) Technical Field

The present invention relates to an information processing apparatus and a non-transitory computer readable medium storing a program.

### (ii) Related Art

Payment methods for purchasing products or services include, for example, payment by cash, bank transfer, payment by electronic money, payment by point, payment by credit card, and payment by crypto asset (crypto currency). The same type of payment method (for example, electronic money) may include plural payment methods.

JP2002-373296A describes a system for distributing billing according to a designated payment method.

JP2005-190481A describes a system which pauses or cancels the account of a customer in a case where payment cannot be secured within a requested time.

JP2003-085454A describes a method of selectively switching a billing method according to a service actually used by a user operating a multifunction peripheral.

JP2017-097812A describes a system in which a transferor limits the use of crypto asset.

JP2017-207860A describes a method of increasing the guarantee of authenticity of transaction information of crypto asset.

JP2018-072981A describes a system which transmits transaction data indicating payment of crypto asset from the account of the user using a user terminal to a non-user's account to a crypto asset network system.

### SUMMARY

By the way, the reception of payment may correspond to plural types of payment methods, in some cases. In this case, in general, a user selects a payment method which is payable by himself or herself from the plural types of payment methods and performs payment. In such a case, even in a case where the user desires to perform payment by a better payment method, it is not easy for the user to determine such a payment method. In other words, depending on the payment method, a campaign (for example, reduction of points or discount) may be implemented, but the campaign may change. In such a case, it is not easy for some user to select a payment method that is better.

Aspects of non-limiting embodiments of the present disclosure relate to an information processing apparatus which performs payment by an appropriate payment method for a user and a non-transitory computer readable medium storing a program.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a reception unit that receives payment by a recommended payment method determined according to a determination criterion for determining the recommended payment method from among one or a plurality of payment methods payable by a user, in a case of receiving a payment request from the user.

### BRIEF DESCRIPTION OF THE DRAWINGS

Exemplary embodiment(s) of the present invention will be described in detail based on the following figures, wherein:

FIG. 1 is a block diagram illustrating a configuration of an information processing system according to a first exemplary embodiment of the present invention;

FIG. 2 is a block diagram illustrating a configuration of a server;

FIG. 3 is a block diagram illustrating a configuration of a terminal apparatus;

FIG. 4 is a block diagram illustrating a configuration of equipment;

FIG. 5 is a diagram illustrating a management table;

FIG. 6 is a diagram illustrating a login screen;

FIG. 7 is a diagram illustrating a payment screen;

FIG. 8 is a diagram illustrating a payment screen;

FIG. 9 is a block diagram illustrating a configuration of an information processing system according to a second exemplary embodiment of the present invention;

FIG. 10 is a block diagram illustrating a configuration of a crypto asset system;

FIG. 11 is a diagram illustrating a block;

FIG. 12 is a diagram illustrating a block;

FIG. 13 is a block diagram illustrating a configuration of a processing apparatus;

FIG. 14 is a block diagram illustrating a configuration of a terminal apparatus;

FIG. 15 is a block diagram illustrating a configuration of equipment;

FIG. 16 is a diagram illustrating a login screen;

FIG. 17 is a diagram illustrating a payment screen;

FIG. 18 is a diagram illustrating a payment screen;

FIG. 19 is a diagram illustrating a payment completion screen;

FIG. 20 is a diagram illustrating a notification screen;

FIG. 21 is a diagram illustrating a transaction checking screen;

FIG. 22 is a diagram illustrating an error screen;

FIG. 23 is a diagram illustrating a notification screen;

FIG. 24 is a diagram illustrating a deposit screen;

FIG. 25 is a diagram illustrating an error screen;

FIG. 26 is a diagram illustrating a notification screen;

FIG. 27 is a diagram illustrating a setting change screen;

FIG. 28 is a block diagram illustrating a configuration of an information processing system according to a third exemplary embodiment of the present invention;

FIG. 29 is a block diagram illustrating a configuration of a crypto asset system;

FIG. 30 is a block diagram illustrating a configuration of a processing apparatus;

FIG. 31 is a diagram illustrating a currency management table;

FIG. 32 is a diagram illustrating a reception result screen;

FIG. 33 is a diagram illustrating a notification screen; and

FIG. 34 is a diagram illustrating a notification screen.

### DETAILED DESCRIPTION

### First Exemplary Embodiment

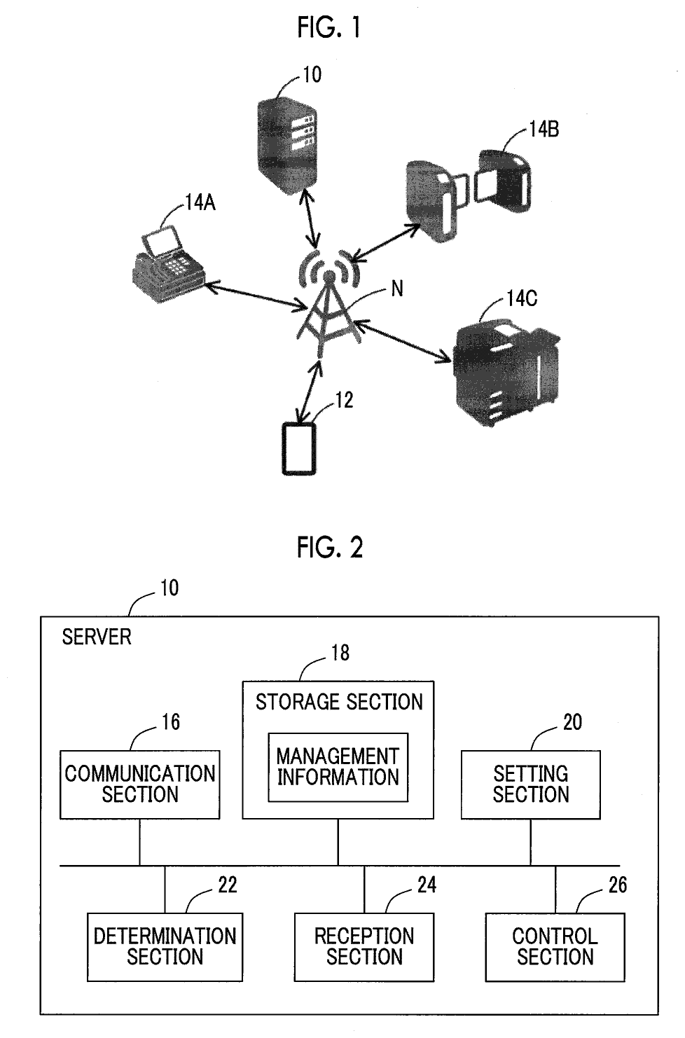

An information processing system according to a first exemplary embodiment of the present invention will be described with reference to FIG. 1. FIG. 1 illustrates the information processing system according to the first exemplary embodiment.

The information processing system according to the first exemplary embodiment includes a server 10, one or plural terminal apparatuses 12, and one or plural pieces of equipment. In the example illustrated in FIG. 1, the information processing system includes equipment 14A, 14B, and 14C. The configuration is only an example, and other equipment may be included in the information processing system. Hereinafter, in a case where it is not necessary to distinguish respective equipment, respective equipment is referred to as “equipment 14”.

The server 10, the terminal apparatus 12, and the equipment 14 each have a function of communicating with other apparatuses. The communication may be wireless communication or wired communication. The server 10, the terminal apparatus 12, and the equipment 14 may communicate with other apparatuses through communication path N such as the Internet or other networks, directly communicate with other apparatuses, or communicate with other apparatuses through a repeater.

In the information processing system according to the first exemplary embodiment, a payment method (payment means) for purchasing products or services is recommended to the user.

The server 10 which is the information processing apparatus is an apparatus which recommends a payment method for purchasing products or services to a user. As payment methods, for example, payment by cash, bank transfer, payment by electronic money, payment by point, payment by credit card, payment by crypto asset (crypto currency), and the like are used. The server 10 may receive payment. In addition, crypto asset will be described in detail in a second exemplary embodiment.

The terminal apparatus 12 is apparatuses such as a personal computer (PC), a tablet PC, a smartphone or a mobile phone. For example, information indicating the payment method recommended by the server 10 is displayed on the terminal apparatus 12. One or plural application software for executing payment may be installed in the terminal apparatus 12. For example, application software for executing payment by electronic money, payment by point, payment by credit card, payment by crypto asset, or the like is installed. Application software for executing payment by using near field communication (NFC) may be installed in the terminal apparatus 12. For example, payment by electronic money may be realized by near field communication.

The equipment 14 is equipment that receives payment from a user, equipment that provides products or services, or the like. In the example illustrated in FIG. 1, as an example of the equipment 14, equipment 14A (register), equipment 14B (automatic ticket gate), and equipment 14C (a multifunction peripheral) are included in the information processing system. A register is equipment which is installed in a store or the like and used for payment. Automatic ticket gates are installed at stations and used for payment of train fares. The multifunction peripheral 14C has an image forming function (a scanning function, a printing function, a copying function, a facsimile function, or the like), and provides services such as copying. The equipment 14 may receive payment by itself, or may provide products or services in a case where other apparatuses such as the server 10 receive payment.

In the first exemplary embodiment, the user may purchase products or services at an actual store or the like, purchase products or services through the Internet (so-called net shopping), or purchase products or services through telecommunication sales through telephone. The first exemplary embodiment may be applied to payment at a bank, payment of insurance, payment for use of the equipment 14, or the like. Of course, products or services may be purchased in other scenes, and the first exemplary embodiment may be applied to payment in other scenes. This also applies to second and third exemplary embodiments to be described later.

Hereinafter, the configuration of the server 10 will be described in detail with reference to FIG. 2. FIG. 2 is an example of the configuration of the server 10.

A communication section 16 is a communication interface, and has a function of transmitting data to other apparatuses and a function of receiving data from other apparatuses. The communication section 16 may be a communication interface having a wireless communication function or a communication interface having a wired communication function.

A storage section 18 is one or plural storage areas for storing various types of information. Each storage area may be defined as one or plural storage devices (physical drives) provided in the server 10, or may be defined as a logical partition or a logical drive set in one or plural storage devices. The storage section 18 may be provided in an apparatus other than the server 10.

The storage section 18 stores management information. The management information is information for managing one or plural payment methods payable by the user, determination elements for determining a determination criterion for determining a payment method recommended to the user, information indicating other attributes of the user, or the like. These pieces of information are managed for each user. A payment method payable by the user and a determination element are also examples of attributes of the user. For example, payment methods payable by the user, determination elements, and other attribute information are registered in the management information in advance.

The determination elements are elements related to the benefits to be given to the user in a case where the user performs payment, for example, a point to be obtained at a time of payment, a rate of a point, an expiration date of the point, versatility of the point, a conversion rate when the point is converted to other points, a discount rate, or the like. Of course, other elements may be used as determination elements. For example, one or plural determination elements are designated by the user.

The setting section 20 is configured to set determination criterion for determining the recommended payment method, based on one or plural determination elements designated by the user. The determination criterion include one or plural determination elements designated by the user. In a case where the determination elements are changed by the user, the determination criterion is also changed.

A determination section 22 is configured to determine a payment method recommended to the user, according to the determination criterion set by a setting section 20, from among one or plural payment methods payable by the user. Hereinafter, the payment method recommended to the user is referred to as the “recommended payment method”. Specifically, the determination section 22 determines a recommended payment method according to one or plural determination elements included in the determination criterion. For example, in a case where a point rate is designated as a determination element, the determination section 22 determines the payment method with the highest point rate as a recommended payment method, from among one or plural payment methods payable by the user.

The determination section 22 may also determine plural ranked recommended payment methods. For example, the determination section 22 may determine the payment method with the highest point rate as a first recommended payment method, determine the payment method with the second highest point rate as a second recommended payment method, and determine the payment method with the third highest point rate as a third recommended payment method. The same applies to the fourth and subsequent payment methods.

In a case where plural determination elements are designated, the setting section 20 may set a determination criterion by applying a weighting process to the plural determination elements, and the determination section 22 may determine a recommended payment method according to the determination criterion. Priority may be set to each determination element. In this case, the setting section 20 sets a determination criterion by applying a weighting process corresponding to the priority.

A reception section 24 is configured to receive payment from the user. Payment may be performed through the terminal apparatus 12, the equipment 14, or other apparatuses. In this case, the reception section 24 receives payment from the terminal apparatus 12 or the like. The reception section 24 has a function of receiving payment and performing settlement. The reception section 24 may be provided in each equipment 14.

The reception section 24 has a function of receiving payment by one or plural payment methods selected from among plural payment methods. For example, the reception section 24 corresponds to plural payment methods such as payment by electronic money, payment by credit card, and payment by crypto asset, and receives payment by one or plural payment methods among these payment methods.

A control section 26 is configured to control the operation of each part of the server 10. The control section 26 is configured to transmit information indicating the recommended payment method determined by the determination section 22 to the terminal apparatus 12 and the equipment 14 by the communication section 16. For example, the information indicating the recommended payment method is displayed on the terminal apparatus 12 and the equipment 14. In a case where plural ranked recommended payment methods are determined, information indicating the plural recommended payment methods is transmitted from the server 10 to the terminal apparatus 12 and the equipment 14 and is displayed on the terminal apparatus 12 and the equipment 14.

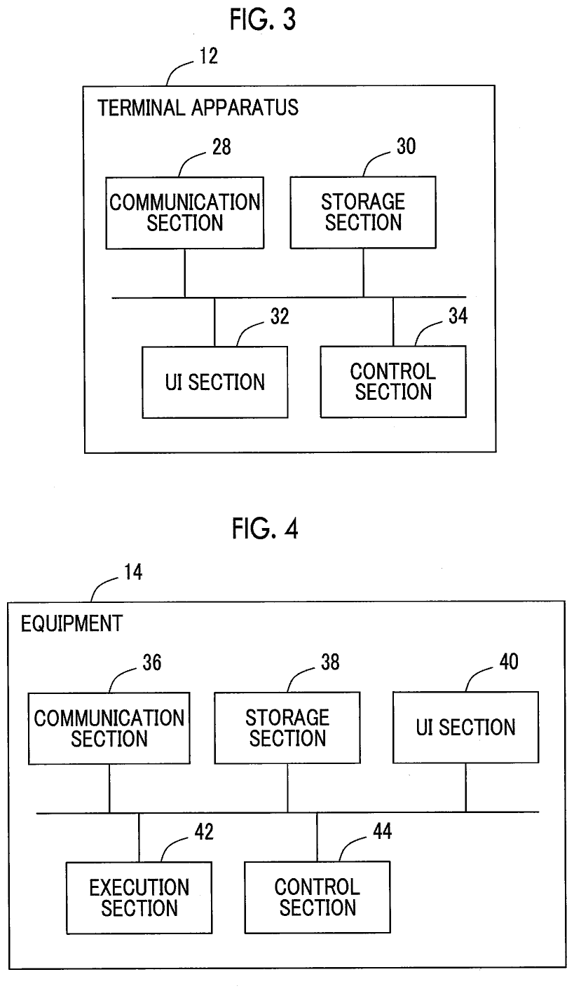

Hereinafter, the configuration of the terminal apparatus 12 will be described in detail with reference to FIG. 3. FIG. 3 is an example of the configuration of the terminal apparatus 12.

A communication section 28 is a communication interface, and has a function of transmitting data to other apparatuses and a function of receiving data from other apparatuses. The communication section 28 may be a communication interface having a wireless communication function or a communication interface having a wired communication function.

A storage section 30 is one or plural storage areas for storing various types of information. Each storage area may be defined as one or plural storage devices (physical drives) provided in the terminal apparatus 12, or may be defined as a logical partition or a logical drive set in one or plural storage devices. One or plural application software for executing payment may be installed in the storage section 30.

A UI section 32 is a user interface, and includes a display section and an operation section. The display section is, for example, a display device such as a liquid crystal display or an EL display. The operation section is, for example, an input device such as a touch panel, a keyboard, and a mouse. The UI section 32 may be a user interface (for example, a touch type display or a device or the like for electronically displaying a keyboard or the like on the display) serving also as a display section and an operation section. The UI section 32 may include a sound collection section such as a microphone, and a sound generation section such as a speaker. In this case, information may be input to the terminal apparatus 12 by voice input or information may be generated by voice.

The control section 34 is configured to control the operation of each part of the terminal apparatus 12. For example, the control section 34 displays information (for example, information indicating a recommended payment method) sent from the server 10 to the terminal apparatus 12, information sent from the equipment 14 to the terminal apparatus 12, or the like, on the display section of the UI section 32.

A part of functions of the server 10 may be provided in the terminal apparatus 12. For example, the management information may be stored in the storage section 30 of the terminal apparatus 12, and the setting section 20, the determination section 22, and the reception section 24 may be provided in the terminal apparatus 12. In this case, in the terminal apparatus 12, a determination criterion is set based on one or plural determination elements, a recommended payment method is determined based on the determination criterion, and the recommended payment method is displayed on the UI section 32. Payment by the user is received by the terminal apparatus 12.

Hereinafter, the configuration of the equipment 14 will be described in detail with reference to FIG. 4. FIG. 4 is an example of the configuration of the equipment 14. FIG. 4 illustrates a configuration which each equipment 14 has in common, and does not illustrate a unique configuration of each equipment 14.

A communication section 36 is a communication interface, and has a function of transmitting data to other apparatuses and a function of receiving data from other apparatuses. The communication section 36 may be a communication interface having a wireless communication function or a communication interface having a wired communication function.

A storage section 38 is one or plural storage areas for storing various types of information. Each storage area may be defined as one or plural storage devices (physical drives) provided in the equipment 14, or may be defined as a logical partition or a logical drive set in one or plural storage devices. The storage section 38 stores, for example, application software or the like for implementing the functions of the equipment 14.

A UI section 40 is a user interface, and includes a display section and an operation section. The display section is, for example, a display device such as a liquid crystal display or an EL display. The operation section is, for example, an input device such as a touch panel, a keyboard, and a mouse. The UI section 40 may be a user interface (for example, a touch type display or a device or the like for electronically displaying a keyboard or the like on the display) serving also as a display section and an operation section. The UI section 40 may include a sound collection section such as a microphone, and a sound generation section such as a speaker. In this case, information may be input to the equipment 14 by voice input, or information may be generated by voice. The equipment 14 may not include the UI section 40.

An execution section 42 is configured to execute functions. For example, in a case where the equipment 14 is the multifunction peripheral 14C, the execution section 42 executes an image forming function such as a scanning function, a printing function, or a copying function.

The control section 44 is configured to control the operation of each part of the equipment 14. For example, the control section 44 displays various types of information on the display section of the UI section 40.

A part of functions of the server 10 may be provided in the equipment 14. For example, the management information may be stored in the storage section 38 of the equipment 14, and the setting section 20, the determination section 22, and the reception section 24 may be provided in the equipment 14. In this case, in the equipment 14, a determination criterion is set based on one or plural determination elements, a recommended payment method is determined based on the determination criterion, and the recommended payment method is displayed on the UI section 40. Payment by the user is received by the equipment 14.

The process of each of the setting section 20, the determination section 22, and the reception section 24 may be performed by the server 10, may be performed by the terminal apparatus 12, or may be performed by the equipment 14. A part of these processes may be performed by any apparatus of the server 10, the terminal apparatus 12, and the equipment 14, and the other processes may be performed by the other apparatuses. Hereinafter, as an example, the server 10 executes these processes.

Hereinafter, the information processing system according to the first exemplary embodiment will be described in detail.

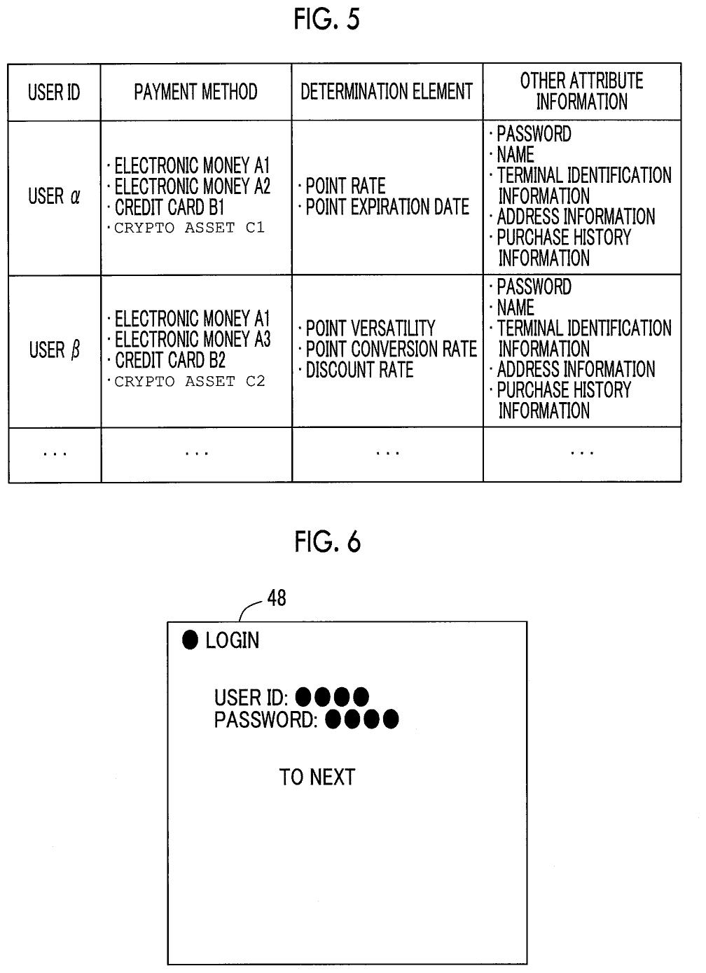

Management information will be described in detail with reference to FIG. 5. FIG. 5 is an example of a management table. The management table is an example of the management information, and data of the management table is stored in advance in the storage section 18 of the server 10.

In the management table, a user ID, information indicating a payment method, information indicating a determination element, and other attribute information are associated with each other for each user. These types of information are registered in the management table in advance. The user ID is an example of user identification information for identifying a user. One or plural payment methods are registered in the management table. The registered payment method is a payment method payable by the user. Determination elements are elements for determining a determination criterion for determining a recommended payment method. The determination elements are designated by, for example, the user. Other attribute information is information indicating the attribute of the user other than the payment method and the determination element. The payment method and the determination element also correspond to the attribute of the user. As other attribute information, for example, a password, a name of a user, identification information of the terminal apparatus 12, address information of the terminal apparatus 12, information indicating purchase history of products or services, or the like are registered in the management table. For example, in a case where the user inputs the attribute information of the user by using the terminal apparatus 12, the attribute information is transmitted from the terminal apparatus 12 to the server 10 and registered in the management table.

For example, a user α can perform payment by electronic money A1, A2, a credit card B1, and a crypto asset C1, and information indicating the electronic money A1, A2, the credit card B1, and the crypto asset C1 is registered in the management table. Information indicating providers (for example, companies) providing electronic money services, credit card companies, providers (for example, companies) providing crypto assets, or the like may be previously collected by the server 10 and registered in the management table. The balance of the electronic money and the crypto asset, the payment capability (upper limit amount, or the like) of the credit card, the point given to the user, the balance of the bank, or the like may be registered in the management table. The server 10 collects the information from management apparatuses (for example, servers) of providers (for example, companies) providing payment methods and the terminal apparatus 12 used by the user, and registers the information in the management table. Payment by cash may be registered as a payment method.

A point rate and a point expiration date are designated by the user α, as determination elements associated with the user α. Priority may be set to each determination element. For example, a determination element that the user α itself considers to be a benefit is designated by the user α. The setting section 20 sets the determination criterion including the point rate and the point expiration date.

A password, the name of the user α, terminal identification information, address information, and purchase history information are registered as other attribute information of the user α. The password is, for example, a password used to log in to the equipment 14, a password used to log in to a Web site (shopping site) for net shopping, or a password used to log in to the server 10. The terminal identification information is information for identifying the terminal apparatus 12 used by the user α, for example, a MAC address or an IP address. The address information is, for example, information indicating the address of the electronic mail associated with the user α. The purchase history information is information indicating a history of purchase of a product or a service by the user α. The purchase history is, for example, a purchase history at an actual store or a purchase history at a shopping site. The purchase history information includes, for example, information indicating a product, or a service purchased by the user, information indicating the price, information indicating the date and time of purchase, and information indicating the number of purchases. The server 10 collects purchase history information of the user α from the equipment 14 installed in an actual store, a shopping site, the terminal apparatus 12, or the like, and registers the collected purchase history information in the management table.

The attribute information of the user 13 and other users is registered in the management table similarly to the attribute information of the user α.

Hereinafter, the determination elements will be described in detail.

The point is received by the user at the time of payment, and is calculated by multiplying the purchase price of a product or service by a point rate, for example. The points may be used for payment at the time of purchase of products or services, or for exchange of presents (products, services, or the like). For example, the points may be usable in a store at the time of purchase, stores of affiliation, a shopping site at the time of purchase, shopping sites of affiliation, or the like. Generally, a payment method with a higher benefit for users such as a payment method by which the user obtains more points is considered.

In a case where a point is designated as a determination element and included in a determination criterion, the determination section 22 determines a recommended payment method based on the point obtained by each payment method. For example, the determination section 22 collects information indicating respective point rates of one or plural payment methods payable by the user, and calculates points obtained by the respective payment methods, based on the purchase price and the point rates of the respective payment methods. The determination section 22 determines, for example, a payment method with the largest number of points obtained by payment, as a recommended payment method. Thus, a payment method which is beneficial to the user with respect to the point is recommended to the user.

The determination section 22 may also determine plural ranked recommended payment methods. For example, the determination section 22 determines a payment method with the largest number of obtained points as a first recommended payment method, and determines a payment method with the second largest number of obtained points as a second recommended payment method. The same applies to the third and subsequent cases.

The point rate (point reduction rate) is the rate of points to be received by the user at the time of payment (rate (%) to purchase price). For example, the point rate is set for each payment method. Of course, a payment method for which the point rate is not set may be registered in the management table. Generally, a payment method with a higher benefit for users such as a payment method with a higher point rate is considered. The point rate is determined by, for example, a seller (for example, a company) selling products or services and an operator (for example, a company) operating a shopping site. The point rate may be constant or varied. For example, a campaign period related to the point rate is set, and during that period, the point rate may be set higher than in other periods. The point rate may be changed according to the number of purchases of products or services, total purchase price, purchase history, paid members, free members, or the like. Of course, the point rate may be changed by other factors.

In a case where a point rate is designated as a determination element and included in a determination criterion, the determination section 22 determines a recommended payment method based on the point rate of each payment method. For example, the determination section 22 collects information indicating respective point rates of one or plural payment methods payable by the user, and determines a payment method with the highest point rate at the time of payment as a recommended payment method. Thus, a payment method which is beneficial to the user with respect to the point rate is recommended to the user.

The determination section 22 may also determine plural ranked recommended payment methods. For example, the determination section 22 determines the payment method with the highest point rate as the first recommended payment method, and determines the payment method with the second highest point rate as the second recommended payment method. The same applies to the third and subsequent cases.

The expiration date of a point may or may not be set. The point where the expiration date is set becomes usable only during the expiration date. The point where the expiration date is not set can be used without limitation of the expiration date. The point may be used from the time when the point is given to the user, or the point may be used during a period after the time. For example, a point expiration date is set for each payment method. Of course, a payment method for which the point expiration date is not set may be registered in the management table. The point expiration date is determined by, for example, a seller (for example, a company) selling products or services and an operator (for example, a company) operating a shopping site. The point expiration date may be constant or varied. For example, the point expiration date may be changed according to the number of purchases of products or services, total purchase price, purchase history, paid members, free members, or the like Of course, the point expiration date may be changed by other factors.

In a case where the point expiration date is designated as a determination element and included in a determination criterion, the determination section 22 determines a recommended payment method based on the point expiration date of each payment method. For example, the determination section 22 collects information indicating respective point expiration dates of one or plural payment methods payable by the user, and determines a point payment method with the longest point expiration date from the time of payment as a recommended payment method. Thus, a payment method which is beneficial to the user with respect to the point expiration date is recommended to the user.

The determination section 22 may also determine plural ranked payment methods. For example, the determination section 22 determines the payment method with the longest point expiration date as the first recommended payment method, and determines the payment method with the second longest point expiration date as the second recommended payment method. The same applies to the third and subsequent cases.

As another example, the determination section 22 may determine the payment method with the shortest point expiration date from the time of payment as a recommended payment method. Thus, the user can be urged to use a payment method with a short point expiration date.

The determination section 22 may determine the payment method with the shortest point expiration date as the first recommended payment method, and determine the payment method with the second shortest point expiration date as the second recommended payment method. The same applies to the third and subsequent cases.

The point versatility is determined by the number of stores and shopping sites where the point is available, the number of types of other convertible points, the conversion rate, or the like. For example, the more the number of available stores and shopping sites of points, the higher the versatility. In addition, the more the number of types of other convertible points, the higher the versatility. The higher conversion rate the point has, the higher the versatility. The versatility of points can be said to be the convenience of points. Of course, the versatility may be determined by other factors. Generally, a payment method with a higher benefit for users such as a payment method by which the user obtains a point with a higher versatility is considered. For example, a point versatility is set for each payment method. Of course, a payment method for which the point versatility is not set may be registered in the management table. The point versatility is determined by, for example, a seller (for example, a company) selling products or services and an operator (for example, a company) operating a shopping site. The point versatility may be changed according to the number of purchases of products or services, total purchase price, purchase history, paid members, free members, or the like. Of course, the point versatility may be changed by other factors.

In a case where versatility of a point is designated as a determination element and included in a determination criterion, the determination section 22 determines a recommended payment method based on the versatility of a point of each payment method. For example, the determination section 22 collects information indicating respective point versatility of one or plural payment methods payable by the user, and determines a payment method with the highest versatility as a recommended payment method. For example, a payment method with the highest number of stores and shopping sites where the point is available is determined as a recommended payment method. Thus, a payment method which is beneficial to the user with respect to the versatility of point is recommended to the user.

The determination section 22 may also determine plural ranked payment methods. For example, the determination section 22 determines the payment method with the highest versatility as the first recommended payment method, and determines the payment method with the second highest versatility as the second recommended payment method. The same applies to the third and subsequent cases.

The point conversion rate is the rate (%) at a time when the point is converted to a different point. Generally, a payment method with a higher benefit for users such as a payment method by which the user obtains a point with higher conversion rate is considered. For example, the point conversion rate is set for each payment method. Of course, a payment method for which the point conversion rate is not set may be registered in the management table. The point conversion rate is determined by, for example, a seller (for example, a company) selling products or services and an operator (for example, a company) operating a shopping site. The point conversion rate may be constant or varied. For example, a campaign period related to the point conversion rate is set, and during that period, the point conversion rate may be set higher than in other periods. The point conversion rate may be changed according to the number of purchases of products or services, total purchase price, purchase history, paid members, free members, or the like. Of course, the point conversion rate may be changed by other factors.

In a case where a point conversion rate is designated as a determination element and included in a determination criterion, the determination section 22 determines a recommended payment method based on the point conversion rate of each payment method. For example, the determination section 22 collects information indicating respective point conversion rates of one or plural payment methods payable by the user, and determines a payment method with the highest conversion rate as a recommended payment method. Thus, a payment method which is beneficial to the user with respect to the conversion rate of point is recommended to the user.

The determination section 22 may also determine plural ranked payment methods. For example, the determination section 22 determines the payment method with the highest conversion rate as the first recommended payment method, and determines the payment method with the second highest conversion rate as the second recommended payment method. The same applies to the third and subsequent cases.

The discount rate is a discount rate (%) of the purchase price of products or services. For example, a discount rate is set for each payment method. Of course, a payment method for which the discount rate is not set may be registered in the management table. Generally, a payment method with a higher benefit for users such as a payment method with a higher discount rate is considered. The discount rate may be constant or varied. For example, a campaign period related to the discount rate is set, and during that period, the discount rate may be set higher than in other periods. The discount rate may be changed according to the number of purchases of products or services, total purchase price, purchase history, paid members, free members, or the like. Different discount rates may be set for each product or service. Of course, the discount rate may be changed by other factors.

In a case where a discount rate is designated as a determination element and included in a determination criterion, the determination section 22 determines a recommended payment method based on the discount rate of each payment method. For example, the determination section 22 collects information indicating respective discount rates of one or plural payment methods payable by the user, and determines a payment method with the highest discount rate as a recommended payment method. Thus, a payment method which is beneficial to the user with respect to the discount rate is recommended to the user.

The determination section 22 may also determine plural ranked payment methods. For example, the determination section 22 determines the payment method with the highest discount rate as the first recommended payment method, and determines the payment method with the second highest discount rate as the second recommended payment method. The same applies to the third and subsequent cases.

The determination section 22 may collect, from a Web site of a provider (for example, a company) providing a payment method, information indicating a point rate for each payment method, information indicating a point expiration date for each payment method, information indicating a point versatility for each payment method, information indicating a point conversion rate for each payment method, and information indicating the discount rate for each payment method, and in case where these types of information are stored in the user's terminal apparatus 12, the determination section 22 may collect these types of information from the terminal apparatus 12. The information may be previously collected and stored in the server 10. For example, the server 10 periodically collects the information and stores it in the storage section 18.

The above determination element is an example, and other determination elements may be designated by the user. In this case, the determination section 22 determines a recommended payment method according to a determination criterion including the other determination elements. The user may designate one determination element or plural determination elements. The determination element may be changed by the user. In this case, the determination criterion is changed according to the change of the determination element.

In a case where plural determination elements are designated by the user, the setting section 20 may set a determination criterion including only one determination element of the plural determination elements, or may set the determination criterion by applying a weighting process to the plural determination elements.

For example, in a case where the priority is set to each determination element designated by the user, the setting section 20 sets a determination criterion based on the priority of each determination element. The priority of each determination element may be designated by the user, or may be predetermined for each determination element. The setting section 20 sets, for example, a determination criterion including only the determination element with the highest priority (a determination criterion including only one determination element). For example, in a case where a point rate and a point expiration date are designated by the user, and “first” is designated as the priority of the point rate, and “second” is designated as the priority of the point expiration date, the setting section 20 sets a determination criterion including only a point rate of priority of “first”. In this case, the determination section 22 determines a payment method with the highest point rate as a recommended payment method.

In a case where the priority is set to each determination element, the setting section 20 may apply a weighting process to each determination element and set a determination criterion including each weighted determination element. For example, “first” is designated as the priority of the point rate, and “second” is designated as the priority of the point expiration date. In this case, a value larger than the weighting factor for the point expiration date is used as the weighting factor for the point rate. That is, the determination criterion for emphasizing the point rate more than the point expiration date is set. The determination section 22 determines a recommended payment method according to the determination criterion. For example, the determination section 22 determines the payment method with the highest point rate and the longest point expiration date as a first recommended payment method, determines the payment method with the highest point rate and not the longest point expiration date as a second recommended payment method, determines the payment method with not the highest point rate and not the longest point expiration date as a third recommended payment method, and determines the payment method with not the highest point rate and the longest point expiration date as a fourth recommended payment method. In this case, the information indicating each of the first to fourth recommended payment methods is transmitted from the server 10 to the terminal apparatus 12, and the information indicating each recommended payment method is ranked and displayed on the terminal apparatus 12. The same applies to the case where three or more determination elements are designated.

Each payment method may be different for each provider (for example, a company) providing a payment method. For example, credit cards of the same type (system) may be from different credit card companies. For example, credit cards of the same type (system) may have different point rates, point expiration dates, versatility, conversion rates, discount rates, or the like depending on credit card companies. The same applies to the electronic money, or the like.

In a case where the obtained point, point rate, point expiration date, versatility, conversion rate, discount rate, or the like is varied, the benefit to be given to the user by payment is varied. As described above, the point rate or the like is changed by the period, the execution of the campaign or the like, and thereby the benefit given to the user is also varied.

Hereinafter, the operation of the information processing system according to the first exemplary embodiment will be described with a specific example. Here, the user α uses the equipment 14C (multifunction peripheral) and pays for the use. In order to facilitate the explanation, the equipment 14C is referred to as the multifunction peripheral 14C.

First, the user α logs in the multifunction peripheral 14C. For example, as illustrated in FIG. 6, a login screen 48 is displayed on the UI section 40 of the multifunction peripheral 14C, and the user α logs in the multifunction peripheral 14C by inputting a user ID and a password associated with the user α on the login screen 48. The user ID and the password are transmitted from the multifunction peripheral 14C to the server 10. Thus, in the server 10, a user α logging in to the multifunction peripheral 14C is specified. Here, as an example, the user ID for logging in to the multifunction peripheral 14C is used as the user ID registered in the management table stored in the server 10. Of course, the user ID for logging in to the multifunction peripheral 14C and the user ID registered in the management table may be different IDs. In this case, on the login screen 48, the user ID for logging in to the multifunction peripheral 14C and the user ID registered in the management table are input by the user α, and these user IDs are transmitted from the multifunction peripheral 14C to the server 10. The multifunction peripheral 14C acquires identification information for identifying the terminal apparatus 12, address information, or the like, by communicating with the terminal apparatus 12 used by the user, and transmits the information to the server 10. Further, the multifunction peripheral 14C transmits information for identifying a store where the multifunction peripheral 14C is installed, information for identifying equipment on which the user α performs payment (for example, the multifunction peripheral 14C), and information for identifying a service used by the user (for example, a service used by the user α on the multifunction peripheral 14C) to the server 10. Thus, the server 10 specifies the store, the equipment (for example, the multifunction peripheral 14C), and the service. In a case where the user α purchases products or services at an actual store, information for identifying the actual store is transmitted to the server 10, but in a case where the user α purchases products or services at a shopping site, information for identifying the shopping site is transmitted to the server 10.

After the user α uses the service provided by the multifunction peripheral 14C, payment for the use is charged. For example, a screen for receiving a payment request from the user α is displayed on the UI section 40 of the multifunction peripheral 14C, and in a case where the user α requests payment on the screen, information indicating the request is transmitted from the multifunction peripheral 14C to the server 10. In a case where receiving information indicating the request, the determination section 22 of the server 10 determines a recommended payment method according to a determination criterion determined by one or plural determination elements previously designated by the user α. Here, as shown in FIG. 5, “point rate” and “point expiration date” are previously designated by the user α as determination elements.

First, the determination section 22 collects information indicating one or plural payment methods payable by the user α on the equipment on which the user α performs payment (for example, a multifunction peripheral 14C), and specifies one or plural payment methods payable on the equipment. For example, the determination section 22 may collect the information from a storage area storing the information (for example, a storage area managed by a provider providing the equipment). The information may be previously stored in the server 10.

The determination section 22 also specifies one or plural payment methods payable by the user α by referring to the management table.

The electronic money A1, A2, the credit card B1, and the crypto asset C1 are payment methods payable by the user α, and payment can be made on the multifunction peripheral 14C by these payment methods.

The determination section 22 acquires information indicating the charge to be paid by the user α (a charge generated by the use of the multifunction peripheral 14C) from the multifunction peripheral 14C, and checks the payment capability of each payment method payable by the user α (for example, the balance of electronic money, the available amount of the credit card, and the balance of crypto asset). Information indicating payment capability of each payment method may be registered in advance in a management table associated with the user α. The determination section 22 may collect information indicating payment capability from a storage area (for example, a storage area managed by a provider providing each payment method) storing information indicating payment capability of each payment method. Then, the determination section 22 specifies one or plural payment methods having the ability to pay a charge to be paid by the user α, among the electronic money A1, A2, the credit card B1, and the crypto asset C1. For example, in a case where the balance of the electronic money or the crypto asset is equal to or more than the charge to be paid by the user α, the electronic money or the crypto asset has the ability to pay the charge. In a case where the available amount of the credit card is equal to or more than the charge to be paid by the user α, the credit card has the ability to pay the charge. Here, all the electronic money A1, A2, the credit card B1, and the crypto asset C1 have the ability to pay a charge to be paid by the user α.

Next, the determination section 22 determines a recommended payment method from among the electronic money A1, A2, the credit card B1, and the crypto asset C1, based on the determination criterion. As described above, since “point rate” and “point expiration date” are designated as the determination elements by the user α, the determination section 22 determines a recommended payment method, based on these determination elements. For example, the priority of the point rate is set to “first” and the priority of the point expiration date is set to “second”. The determination section 22 may determine a recommended payment method, based on only the point rate of the first priority, or may determine a recommended payment method according to a determination criterion obtained by applying the weighting process to the point rate and the point expiration date. The determination section 22 may also determine plural ranked recommended payment methods. Information indicating one or plural recommended payment methods is sent from the server 10 to the terminal apparatus 12 or the multifunction peripheral 14C, and is displayed on the terminal apparatus 12 or the multifunction peripheral 14C.

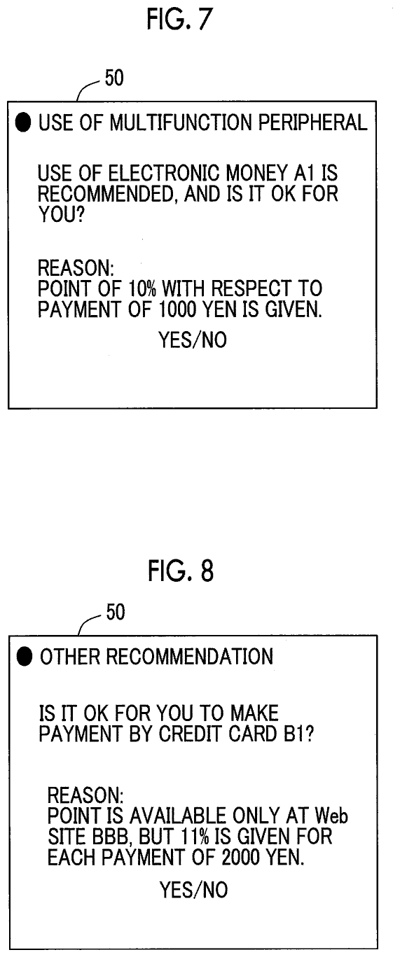

Here, the information indicating one or plural recommended payment methods is sent from the server 10 to the multifunction peripheral 14C, and is displayed on the multifunction peripheral 14C. For example, as shown in FIG. 7, a payment screen 50 is displayed on the UI section 40 of the multifunction peripheral 14C. Information indicating the recommended payment method determined by the determination section 22 is displayed on the payment screen 50. Here, plural ranked recommended payment methods are determined, and information indicating a first recommended payment method is displayed on the payment screen 50.

For example, among the electronic money A1, A2, the credit card B1 and the crypto asset C1, the electronic money A1 with the highest point rate and the longest point expiration date is determined as the first recommended payment method, and the information indicating the electronic money A1 is displayed on the payment screen 50. The reason why the electronic money A1 is recommended may be displayed on the payment screen 50. The reason may not be displayed. Thus, since information indicating the recommended payment method is displayed before the reception section 24 receives the payment, the recommended payment method is notified to the user.

In a case where user α presses a “yes” button on the payment screen 50, a payment method is determined as the electronic money A1, and payment using the electronic money A1 is performed. For example, the reception section 24 provided in the server 10 may receive payment by the electronic money A1, or the multifunction peripheral 14C may have the reception section 24 provided therein to receive payment by the electronic money A1, on the multifunction peripheral 14C. An application for executing payment by the electronic money A1 may be installed in the terminal apparatus 12, and payment by the electronic money A1 may be performed by the application. Thus, in a case where the user α receiving the notification of the recommended payment method determines payment by the recommended payment method, payment using the recommended payment method is performed.

In a case where the user α presses a “no” button on the payment screen 50, information indicating a second recommended payment method is displayed on the payment screen 50. For example, a credit card B1 having the second highest point rate and the second longest point expiration date is determined as the second recommended payment method. In this case, as shown in FIG. 8, information indicating the credit card B1 is displayed on the payment screen 50. Similarly to the electronic money A1, the reason why the credit card B1 is recommended may be displayed on the payment screen 50. In a case where the user α presses a “yes” button, payment using the credit card B1 is performed. In a case where a third recommended payment method is determined and the user α presses a “no” button, information indicating the third recommended payment method is displayed on the payment screen 50. The same applies to fourth and subsequent recommended payment methods.

Information indicating the recommended payment method for each rank may be displayed on the screen according to the scroll form. For example, information indicating each recommended payment method is displayed according to a rank.

As described above, since the recommended payment method determined according to the determination criterion for determining the recommended payment method is presented to the user, the user is able to perform payment by an appropriate payment method for the user.

The setting section 20 may determine a determination criterion based on one or plural determination elements at a time when the reception section 24 receives a payment request, that is, at the time of payment, or may determine a determination criterion based on one or plural determination elements at a time designated by the user. The determination section 22 determines a recommended payment method according to such a determination criterion. Divided payment may be designated as a payment method. In a case where divided payment is designated and a determination criterion is determined based on the determination elements at the time of payment, the payment method may be changed for each payment.

The determination section 22 may execute simulation of the payment charge. Information indicating the simulation result is transmitted from the server 10 to the terminal apparatus 12 and is displayed on the terminal apparatus 12. For example, in a case where the user inputs the price of a product or a service (a purchase object) to be purchased by using the terminal apparatus 12, information indicating the charge is transmitted from the terminal apparatus 12 to the server 10. The determination section 22 determines a recommended payment method, based on the price of the purchase object and the determination criterion. For example, in a case where a point rate is designated as a determination element, the determination section 22 calculates points obtained by each payment method based on the price of the purchase object and the point rate of each payment method, and determines a payment method by which the most points are obtained is determined as the recommended payment method. The point rate of each payment method may be changed depending on the purchase object. The information indicating the recommended payment method is transmitted from the server 10 to the terminal apparatus 12 as information indicating the simulation result, and displayed on the terminal apparatus 12. Thus, a recommended appropriate payment method for purchase is presented to the user even in a case where the user does not actually purchase products or services. For example, the simulation is executed before the user purchases a product or a service.

The setting section 20 may changes the determination element designated by the user to another determination element to determine the determination criterion, based on a purchase history of the user. The determination section 22 determines a recommended payment method according to the changed determination criterion.

The information indicating the purchase history includes, for example, information indicating the product or service purchased by the user, information indicating the purchase price, information indicating the purchase date and time, and information indicating the store or shopping site where the user performs purchasing. Information indicating the purchase history is stored in the server 10, for example. Each time the user purchases a product or service, information indicating the purchase history is transmitted from a store, a shopping site, the terminal apparatus 12, or the like, to the server 10 and is stored in the server 10.

For example, even in a case where the point versatility is designated by the user as the determination element, in a case where the rate of points available in stores or shopping sites that are frequently used by the users is high, the setting section 20 determines the determination criterion by using the point rate as the determination element, without using the point versatility as the determination element. In this case, the determination section 22 determines a recommended payment method, based on the point rate.

The setting section 20 may determine a determination criterion by setting the priority of the point rate to “first” and setting the priority of the point versatility to “second”.

The frequency of use is calculated based on the purchase history. For example, stores and shopping sites where the total number of use by users is a threshold or more may correspond to stores and shopping sites that are frequently used, stores and shopping sites where the number of use during a predetermined unit period is a threshold or more may correspond to stores and shopping sites that are frequently used, or a predetermined number of top stores and shopping sites in descending order of frequency of use may correspond to stores and shopping sites that are frequently used. A point of which the point rate becomes a threshold or more corresponds to a point of which the point rate is high. Each threshold may be predetermined or changed by the user or the like.

Since determination criterion is determined based on the purchase history, a recommended payment method considering the purchase history is presented to the user.

The determination section 22 may determine the recommended payment method based on the history of the user's payment method. The information indicating the payment method history includes, for example, information indicating the payment method used by the user and information indicating the date and time when the payment is performed. The information indicating the payment method history may include information indicating the purchase history. Information indicating the payment method history is stored in the server 10, for example. Each time the user purchases a product or service, information indicating a payment method used at the time of purchase is transmitted as the information indicating the purchase method history from a store, a shopping site, the terminal apparatus 12, or the like, to the server 10 and is stored in the server 10.

For example, the determination section 22 determines payment methods that are frequently used as recommended payment methods. For example, payment methods in which the total number of use by users is a threshold or more may correspond to payment methods that are frequently used, payment methods in which the number of use during a predetermined unit period is a threshold or more may correspond to payment method that are frequently used, or a predetermined number of top payment methods in descending order of frequency of use may correspond to payment methods that are frequently used. The threshold may be predetermined or changed by the user or the like.

In a case where one or plural payment methods payable by the user include a payment method in which the remaining valid period is a threshold or less, the determination section 22 determines the payment method as a recommended payment method, and the reception section 24 receives payment by the recommended payment method. The valid period may be, for example, the valid period of the point obtained by using the payment method (a period during in a case where the point is available), or the valid period of the payment method (a period during in a case where the payment method is available). Information indicating plural payment methods in which a remaining valid period is a threshold or less may be displayed on the terminal apparatus 12. The threshold may be predetermined or changed by the user or the like. Since information indicating a payment method in which a remaining valid period is a threshold or less is displayed as information indicating a recommended payment method, for example, the user can be urged to use a payment method that close to the expiration date.

The determination section 22 may rank each payment method based on the remaining valid period. For example, a higher rank is given to a payment method with fewer remaining valid period. Information indicating each payment method may be displayed on the terminal apparatus 12 according to the rank.

The determination section 22 may change the recommended payment method for each product or service to be purchased. For example, it is assumed that the determination criterion includes a point rate as a determination element, and a recommended payment method is determined based on the point rate. For example, in a case where the rate of points obtained by using electronic money A1 is 10% and the rate of points obtained by using electronic money A2 is 5% in a case where purchasing the product A, the determination section 22 determines the electronic money A1 as a recommended payment method to be used for purchasing the product A. On the other hand, in a case where the rate of points obtained by using electronic money A1 is 5% and the rate of points obtained by using electronic money A2 is 10% in a case where purchasing the product B, the determination section 22 determines the electronic money A2 as a recommended payment method to be used for purchasing the product B.

In the case of purchasing both the products A and B, the determination section 22 determines a payment method with the largest number of obtained points as a recommended payment method. For example, in a case where points obtained in a case where products A, B are purchased by electronic money A1 are 1,000 points and points obtained in a case where products A, B are purchased by electronic money A2 are 1500 points, the determination section 22 determines the electronic money A2 as the recommended payment method. The obtained points are obtained, for example, by multiplying the purchase price of the product by the point rate. For example, in a case where the purchase price is 1,000 yen and the point rate is 10%, the obtained point is 100 points.

The determination section 22 may determine a payment method for reducing the substantial payment of the user as a recommended payment method. For example, information indicating the point balance (the balance of points available for payment) of each payment method available to the user is stored in the server 10 associated with the user. The determination section 22 determines a payment method with the largest point balance as a recommended payment method. Since the payment method with the largest point balance has more price that can be paid by points than other payment methods, this is a payment method with less substantial payment by the user. Thus, by determining such a payment method as the recommended payment method, the payment method for reducing the substantial payment of the user is presented to the user. The determination section 22 may rank each payment method in a descending order of a point balance of each payment method. In this case, information indicating each payment method is displayed on the terminal apparatus 12 according to the rank.

The determination section 22 may specify a store or a shopping site where the user can purchase the same product or service as the product or service that the user intends to purchase, and where the substantial payment of the user is reduced. Information indicating the store, or the shopping site specified in this way is transmitted from the server 10 to the terminal apparatus 12 and displayed on the terminal apparatus 12. Here, the substantial payment is, for example, a price obtained by subtracting points obtained by the payment at a store or a shopping site from the purchase price.

The determination section 22 may predict the merit for the user with consideration of factors such as the current payment, the intermediate period, and the next payment, and predict the payment method that is predicted to be very benefit to the user as the recommended payment method of the current time. The intermediate period is a period between the current payment and the next payment. For example, points are given to the user by the current payment, and the user holds the points during the intermediate period. The determination section 22 may determine, for example, a payment method in which points obtained by the current payment increase during an intermediate period as a current recommended payment method, or determine a payment method in which the increase rate is maximum as a current recommended payment method. The current payment corresponds to an element as an entrance in the sense that points are obtained, and the next payment corresponds to an element as an exit in the sense that points are used. The determination section 22 may determine a payment method for obtaining a point convertible to a point usable for the next payment (for example, a store or a shopping site for next shopping) in an intermediate period as the current recommended payment method. For example, in a case where the user designates next payment (a store or a shopping site for next shopping) by using the terminal apparatus 12, information indicating the next payment is transmitted from the terminal apparatus 12 to the server 10, and the determination section 22 recognizes the next payment. The determination section 22 may predict the next payment following the current payment, based on the purchase history of the user.

In a case where the user performs the next shopping at the same store or shopping site as the current store or shopping site, the determination section 22 may determine a payment method for obtaining points usable at the store or the shopping site as the current recommended payment method. For example, in a case where the user uses the terminal apparatus 12 to input information indicating a store or a shopping site where the next shopping is performed, the information is transmitted from the terminal apparatus 12 to the server 10, and the determination section 22 recognizes that the next shopping is performed at the same store or shopping site as the current store or shopping site. The determination section 22 may predict the next payment following the current payment, based on the purchase history of the user.

### Second Exemplary Embodiment

Hereinafter, an information processing system according to a second exemplary embodiment of the present invention will be described. The information processing system according to the second exemplary embodiment provides a technique for enabling proper use of a crypto asset (crypto currency).

A crypto asset is managed by, for example, a distributed network using a technique called a block chain. In the transaction by the crypto asset, the authenticity of the transaction data is secured by using a hash function and a public key encryption system. Transaction information of the crypto asset performed by using an encryption technique is transmitted by broadcast to a terminal apparatus using the crypto asset. The authenticity of the transmitted transaction information is verified by a terminal apparatus called a minor (mining person), and in a case where the authenticity is approved, the information is collected into blocks and recorded in a ledger called a block chain.

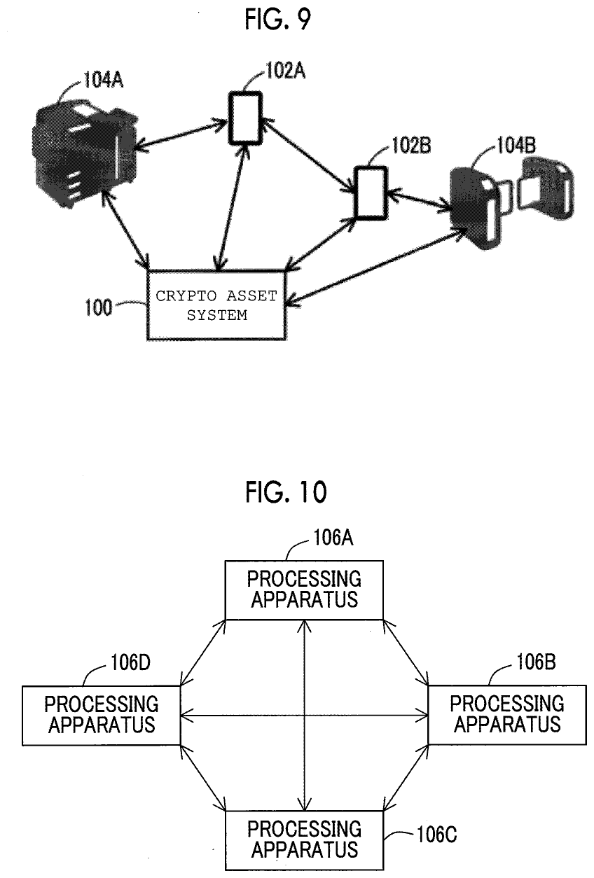

The information processing system according to the second exemplary embodiment will be described with reference to FIG. 9. FIG. 9 illustrates an example of the information processing system according to the second exemplary embodiment.

The information processing system according to the second exemplary embodiment includes a crypto asset system 100, one or plural terminal apparatuses, and one or plural pieces of equipment. In the example shown in FIG. 9, the information processing system includes terminal apparatuses 102A, 102B, and equipment 104A, 104B. This configuration is only an example, and other terminal apparatuses and other equipment may be included in the information processing system. Hereinafter, in a case where it is not necessary to distinguish respective terminal apparatuses, the respective terminal apparatuses are referred to as “terminal apparatus 102”. Further, in a case where it is not necessary to distinguish respective equipment, respective equipment is referred to as “equipment 104”.

The crypto asset system 100, the terminal apparatus 102, and the equipment 104 each have a function of communicating with other apparatuses. The communication may be wireless communication or wired communication. The crypto asset system 100, the terminal apparatus 102, and the equipment 104 may communicate with other apparatuses through communication path such as the Internet or other networks, directly communicate with other apparatuses, or communicate with other apparatuses through a repeater.

The terminal apparatus 102 is an apparatus such as a PC, a tablet PC, a smartphone, or a mobile phone. Application software for executing payment by crypto asset is installed in the terminal apparatus 102, and the terminal apparatus 102 is an apparatus performing transaction by using the crypto asset.

The equipment 104 is equipment that receives payment from a user, equipment that provides products or services, or the like. In the example illustrated in FIG. 9, as an example of the equipment 104, equipment 104A (a multifunction peripheral) and equipment 104B (an automatic ticket gate) are included in the information processing system. The equipment 104 may receive payment by itself, or may provide products or services in a case where other apparatuses such as the server receive payment.

The terminal apparatus 102 and the equipment 104 can transmit and receive transaction information to and from the crypto asset system 100. For example, in a case where a crypto asset is remitted from a terminal apparatus 102B to a terminal apparatus 102A, transaction information indicating that the remittance has been made is transmitted to the crypto asset system 100.

Hereinafter, a crypto asset system 100 will be described with reference to FIG. 10. FIG. 10 illustrates an example of the configuration of the crypto asset system 100. The crypto asset system 100 is a distributed network system including plural processing apparatuses (for example, processing apparatuses 106A, 106B, 106C, and 106D). Hereinafter, in a case where it is not necessary to distinguish respective processing apparatuses, the respective processing apparatuses are referred to as “processing apparatus 106”. The crypto asset system 100 has a configuration of a peer-to-peer (P2P) type in which plural processing apparatuses 106 communicate with each other, and respective processing apparatuses 106 are connected to each other to manage the same data.

In the example shown in FIG. 10, although four processing apparatuses 106 are included in the crypto asset system 100, the number of processing apparatuses 106 is not limited thereto.

The processing apparatus 106 is, for example, an apparatus such as a PC, a tablet PC, a smartphone, or a mobile phone. Crypto asset management software is installed in the processing apparatus 106, and the processing apparatus 106 is an apparatus that performs transaction by using a crypto asset and verifies and approves the transaction information. In the examples shown in FIG. 9 and FIG. 10, the terminal apparatus 102 and the equipment 104 are not included in the crypto asset system 100, but the terminal apparatus 102 and the equipment 104 may also be included in the crypto asset system 100 to constitute the crypto asset system 100, similarly to the processing apparatus 106. Namely, the terminal apparatus 102 and the equipment 104 may also be connected to the other apparatus, similarly to the processing apparatus 106, and verifies or approves the transaction data.

A part of information handled by the crypto asset system 100 may be collected by a centralized apparatus (for example, a server), without being synchronized between apparatuses by P2P type communication.

Account addresses are distributed to the terminal apparatus 102 and the processing apparatus 106, and the purchase and transaction of the crypto asset become possible. Information and history on the transaction of the crypto asset are distributed and managed as a block chain in the entire crypto asset system 100. Namely, a block including plural pieces of transaction information of the crypto asset is successively connected to a block generated one before the block, and each of blocks connected in this manner is managed by each of the plural processing apparatuses 106.

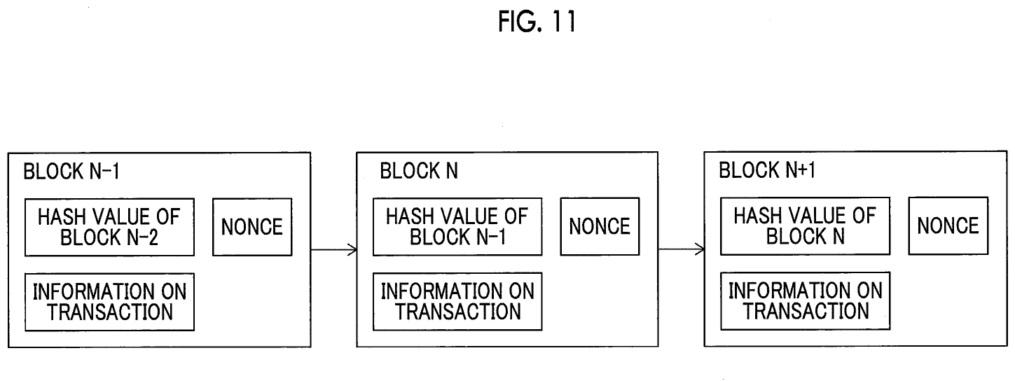

Hereinafter, a block will be described with reference to FIG. 11. FIG. 11 is an example of a block. In the example shown in FIG. 11, blocks are successively connected by a series of connection (chain connection) in the order of blocks N−1, N and N+1. The block N includes a hash value of a block N−1 which is a preceding block of the block N, information on transaction (transaction information), and data called nonce. The hash value of the block N is generated by performing arithmetic operation by using these three data. The hash value is taken over to a block N+1 which is the subsequent block of the block N. In this manner, the blocks are successively connected. In a case where the data in the block is tampered with, the hash value changes, and the hash values of the blocks all become different after the data-tampering, so it is easy to identify the tampered portion. The hash value corresponds to an example of identification information for maintaining the identity of the crypto asset.

The transaction information of the block N includes data of individual transactions. For example, the transaction data of “10 BTC is paid from a user A to a user B” is included in transaction information. Here, the BTC is a currency unit of a bit coin as an example of a crypto asset. The crypto asset system 100 collects plural items of transaction data and manages the collected data as one block. The balance of the account of the user using the crypto asset system 100 is specified by referring to the transaction data.

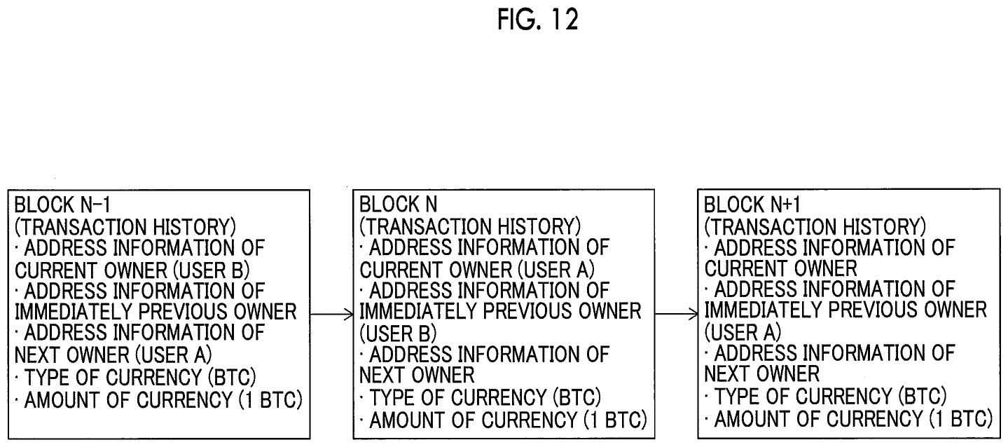

Hereinafter, transaction history recorded in a block will be described with reference to FIG. 12. FIG. 12 illustrates an example of a block. For example, crypto asset of 1 BTC is remitted from the user B to the user A, and the transaction data is included in transaction information of the block N, as a transaction history. Transaction information of the block N includes, as a transaction history, information for identifying the current owner (user A) of 1 BTC (for example, the address information of the user A), information for identifying the immediately previous owner (user B) of the 1 BTC (for example, the address information of the user B), information indicating the type of the crypto asset used for the transaction, and information indicating the amount of the currency. In a case where it is determined that the user A remits the 1 BTC to another user (for example, the user C), information (for example, address information of the user C) for identifying the next owner (user C) may be included in the transaction information of the block N. The same applies to the blocks N−1, N+1. By referring to the transaction history, a source is specified from which (from whom) the crypto asset is sent, and a destination is specified to which the crypto asset is paid.

In the second exemplary embodiment, in a case where the user A performs transaction by using the crypto asset, information indicating that the transaction is performed is notified to the user B who has transferred (remitted) the crypto asset to the user A. For example, information indicating the fact is transmitted from the crypto asset system 100 to the address of the user B (for example, the terminal apparatus 102 used by the user B) and is displayed on the terminal apparatus 102. The same applies to the case where another user performs transaction by using the crypto asset.

The security of the crypto asset may be further enhanced by including information indicating the account of the user, information for identifying the terminal apparatus 102 and the equipment 104, and information indicating the limitation of transaction time in each block.

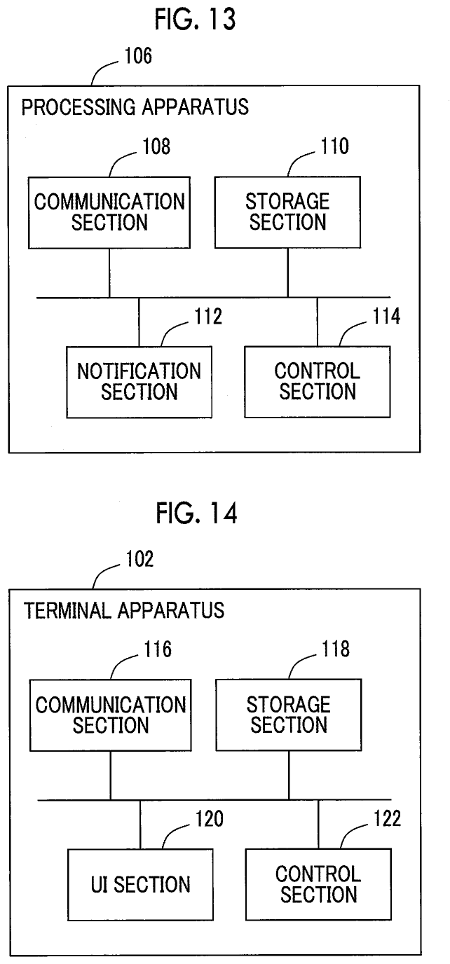

Hereinafter, the configuration of the processing apparatus 106 will be described in detail with reference to FIG. 13. FIG. 13 illustrates an example of the configuration of the processing apparatus 106.

A communication section 108 is a communication interface, and has a function of transmitting data to other apparatuses and a function of receiving data from other apparatuses. The communication section 108 may be a communication interface having a wireless communication function or a communication interface having a wired communication function.

A storage section 110 is one or plural storage areas for storing various types of information. Each storage area may be defined as one or plural storage devices (physical drives) provided in the processing apparatus 106, or may be defined as a logical partition or a logical drive set in one or plural storage devices.

A notification section 112 is configured to notify a user who has transferred (remitted) crypto asset of information indicating that transaction has been performed in a case where the user performs the transaction by using the crypto asset. The notification section 112 specifies the destination of notification by referring to address information recorded in a block shown in FIG. 12, for example, and notifies the destination of the notification of the information.

The control section 114 is configured to control the operation of each part of the processing apparatus 106. For example, since the storage section 110 stores crypto asset management software, and the control section 114 executes the crypto asset management software, transaction using the crypto asset, and verification and approval of transaction information are performed.

Hereinafter, the configuration of the terminal apparatus 102 will be described in detail with reference to FIG. 14. FIG. 14 illustrates an example of the configuration of the terminal apparatus 102.

A communication section 116 is a communication interface, and has a function of transmitting data to other apparatuses and a function of receiving data from other apparatuses. The communication section 116 may be a communication interface having a wireless communication function or a communication interface having a wired communication function.

A storage section 118 is one or plural storage areas for storing various types of information. Each storage area may be defined as one or plural storage devices (physical drives) provided in the terminal apparatus 102, or may be defined as a logical partition or a logical drive set in one or plural storage devices.

A UI section 120 is a user interface, and includes a display section and an operation section. The display section is, for example, a display device such as a liquid crystal display or an EL display. The operation section is, for example, an input device such as a touch panel, a keyboard, and a mouse. The UI section 120 may be a user interface (for example, a touch type display or a device or the like for electronically displaying a keyboard or the like on the display) serving also as a display section and an operation section. The UI section 120 may include a sound collection section such as a microphone, and a sound generation section such as a speaker. In this case, information may be input to the terminal apparatus 102 by voice input or information may be generated by voice.

The control section 122 is configured to control the operation of each part of the terminal apparatus 102. For example, since the storage section 118 stores software for executing payment by crypto asset, and the control section 122 executes the software, transaction using the crypto asset is performed. Of course, since crypto asset management software is stored in the storage section 118 and the crypto asset management software is executed, verification and approval of transaction information may be performed.

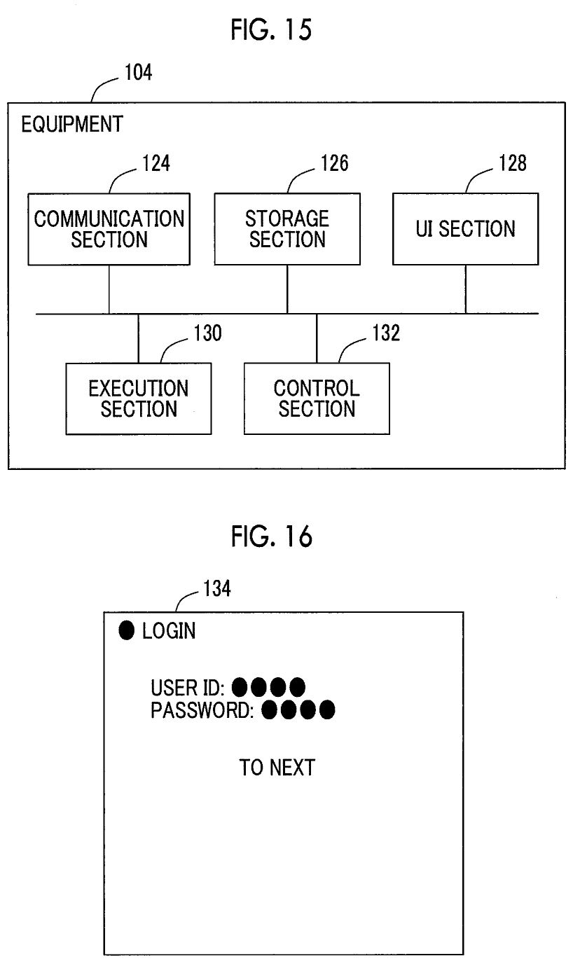

Hereinafter, the configuration of the equipment 104 will be described in detail with reference to FIG. 15. FIG. 15 illustrates an example of the configuration of the equipment 104. FIG. 15 illustrates a configuration which each equipment 104 has in common, and does not illustrate a unique configuration of each equipment 104.

A communication section 124 is a communication interface, and has a function of transmitting data to other apparatuses and a function of receiving data from other apparatuses. The communication section 124 may be a communication interface having a wireless communication function or a communication interface having a wired communication function.

A storage section 126 is one or plural storage areas for storing various types of information. Each storage area may be defined as one or plural storage devices (physical drives) provided in the equipment 104, or may be defined as a logical partition or a logical drive set in one or plural storage devices. The storage section 126 stores, for example, application software or the like for implementing the functions of the equipment 104.

A UI section 128 is a user interface, and includes a display section and an operation section. The display section is, for example, a display device such as a liquid crystal display or an EL display. The operation section is, for example, an input device such as a touch panel, a keyboard, and a mouse. The UI section 128 may be a user interface (for example, a touch type display or a device or the like for electronically displaying a keyboard or the like on the display) serving also as a display section and an operation section. The UI section 128 may include a sound collection section such as a microphone, and a sound generation section such as a speaker. In this case, information may be input to the equipment 104 by voice input, or information may be generated by voice. The equipment 104 may not include the UI section 128.

An execution section 130 is configured to execute functions. For example, in a case where the equipment 104 is a multifunction peripheral 104A, the execution section 130 executes an image forming function such as a scanning function, a printing function, or a copying function.

The control section 132 is configured to control the operation of each part of the equipment 104.

The notification section 112 may be included in the equipment 104. In this case, in a case where a transaction using the crypto asset is performed for the equipment 104, the notification section 112 of the equipment 104 notifies the user who has transferred (remitted) the crypto asset to a user who has used the crypto asset of information indicating that the transaction is performed.

Hereinafter, the operation of the information processing system according to the second exemplary embodiment will be described with a specific example. In this case, the crypto asset is remitted from the user B to the user A, and then the user A uses the equipment 104A (multifunction peripheral) and performs payment for the use by the crypto asset. Namely, in the block chain, up to block N−1 shown in FIG. 12 is generated, and a block N is generated and is connected to a block N−1 by the user using the crypto asset. For example, the user A is an employee of a company, the user B is an accounting personnel of the company, a crypto asset A as expenses is remitted from the user B to the user A, and the user A performs transaction using the crypto asset A. The user A uses the crypto asset A itself as a source, and uses crypto assets B, C, or the like, by breaking the crypto asset A. Namely, the user A can use the crypto asset up to the amount of the crypto asset A in total. In order to facilitate the explanation, the equipment 104A is referred to as a multifunction peripheral 104A.

First, the user A logs in the multifunction peripheral 104A. For example, as shown in FIG. 16, a login screen 134 is displayed on the UI section 128 of the multifunction peripheral 104A, and the user A logs in the multifunction peripheral 104A by inputting a user ID and a password associated with the user A, on the login screen 134. The user ID and the password are transmitted from the multifunction peripheral 104A to the crypto asset system 100. Thus, in the crypto asset system 100, the user A logging in to the multifunction peripheral 104A is specified. The multifunction peripheral 104A acquires identification information for identifying the terminal apparatus 102A, address information, or the like, by communicating with the terminal apparatus 102A used by the user A, and transmits the information to the crypto asset system 100. Further, the multifunction peripheral 104A transmits information for identifying a store where the multifunction peripheral 104A is installed, information for identifying equipment on which the user A performs payment (for example, the multifunction peripheral 104A), and information for identifying a service used by the user (for example, a service used by the user A on the multifunction peripheral 104A) to the crypto asset system 100. Thus, in the crypto asset system 100, the store, the equipment (for example, the multifunction peripheral 104A), and the service are specified. In a case where the user A purchases products or services at an actual store, information for identifying the actual store is transmitted to the crypto asset system 100, but in a case where the user A purchases products or services at a shopping site, information for identifying the shopping site is transmitted to the crypto asset system 100.

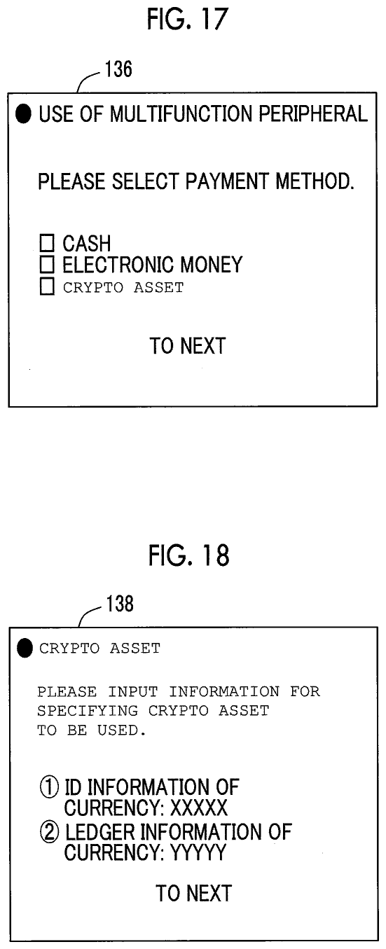

After the user A uses the service provided by the multifunction peripheral 104A, payment for the use is charged. For example, as shown in FIG. 17, a payment screen 136 is displayed on the UI section 128 of the multifunction peripheral 104A. On the payment screen 136, information indicating a payment method capable of being paid on the multifunction peripheral 104A is displayed. Here, since payment by cash, electronic money, and crypto asset is possible, information indicating this fact is displayed.

In a case where the user A selects payment by a crypto asset on the payment screen 136, as shown in FIG. 18, a payment screen 138 for inputting information about the crypto asset is displayed on the UI section 128 of the multifunction peripheral 104A, as shown in FIG. 18. For example, on the payment screen 138, the user A inputs an ID for specifying a crypto asset (for example, a crypto asset A transferred from a user B) used for payment and information for specifying a ledger (block chain) of the crypto asset. The user A using the crypto asset is specified, based on the information inputted at the time of login, the crypto asset ID, and the ledger information.

In a case where the user A instructs payment on the payment screen 138 (for example, a case where a “next” button is pressed by the user A), information on transaction performed by the multifunction peripheral 104A is transmitted from the multifunction peripheral 104A to the crypto asset system 100. For example, information on transactions including information inputted at the time of login, a crypto asset ID and ledger information is transmitted from the multifunction peripheral 104A to the crypto asset system 100.

In the crypto asset system 100, the transaction information is verified and approved. In a case where the user A has a crypto asset sufficient for payment, the currency (for example, the crypto asset B) for the charge is broken from the crypto asset (for example, the crypto asset A) and payment is performed. The history is recorded as a block N shown in FIG. 12. The amount of the crypto asset possessed by the user A after payment is “crypto asset A-crypto asset B”. For example, in a case where the amount of the crypto asset transferred from the user B corresponds to 10,000 yen, in a case where the payment charge does not exceed the amount, the payment is normally performed. In a case where restriction that only payment from a specific user is received is imposed by an instruction from the user B, the authentication is also performed by the crypto asset system 100.

In a case where payment is normally completed, the notification section 112 transmits information indicating that the user A performs a transaction by a crypto asset (for example, the crypto asset B broken from the crypto asset A) on the multifunction peripheral 104A, to the terminal apparatus 102B used by the user B. The information is displayed on the UI section 120 of the terminal apparatus 102B. Information indicating the address of the terminal apparatus 102B used by the user B is recorded in the block N−1.

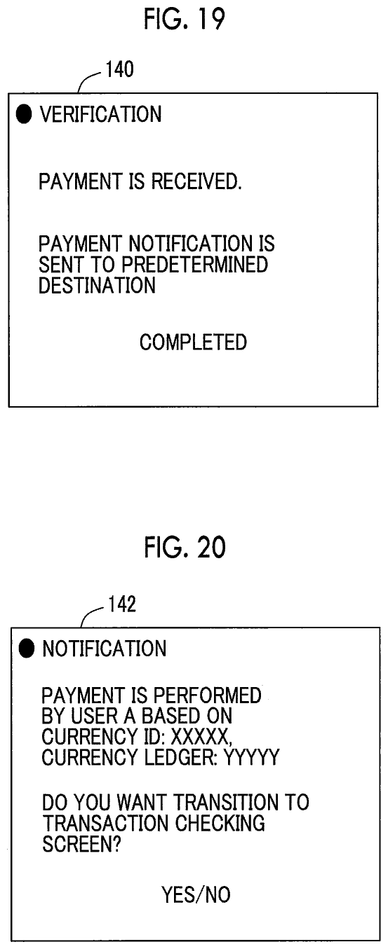

In a case where the payment is normally completed, a payment completion screen 140 is displayed on the UI section 128 of the multifunction peripheral 104A as shown in FIG. 19. The payment completion screen 140 is generated by the crypto asset system 100, and information on the payment completion screen 140 is transmitted from the crypto asset system 100 to the multifunction peripheral 104A, and the payment completion screen 140 is displayed on the UI section 128. On the payment completion screen 140, information indicating that payment is normally received, and information indicating that payment notification is transmitted to a predetermined destination (for example, a terminal apparatus 102B used by a user B) are displayed.

Hereinafter, information displayed on the terminal apparatus 102B will be described with reference to FIG. 20. FIG. 20 illustrates an example of the notification screen. In a case where information indicating that the user A has made a transaction by crypto asset on the multifunction peripheral 104A is transmitted to the terminal apparatus 102B used by the user B, as illustrated in FIG. 20, the control section 122 of the terminal apparatus 102B displays a notification screen 142 for notifying the user B of the information on the UI section 120. The information on the notification screen 142 is generated by the crypto asset system 100. On the notification screen 142, information indicating that payment based on the crypto asset is performed by the user A to which the user B has transferred the crypto asset (for example, the crypto asset A) is displayed. For example, a currency ID and information indicating a currency ledger are displayed.

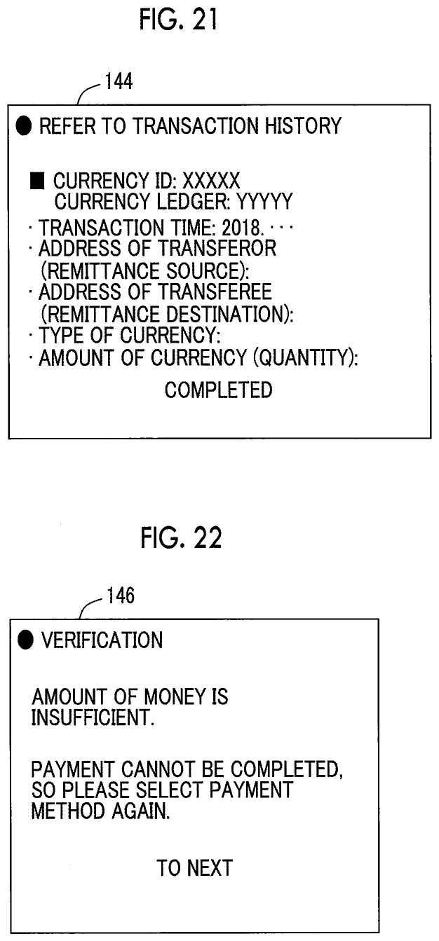

In a case where the user B instructs transition to a transaction checking screen on the notification screen 142 (for example, in a case of pressing a “yes” button), as shown in FIG. 21, a transaction checking screen 144 is displayed on the UI section 120 of the terminal apparatus 102B. The information on the transaction checking screen 144 is generated by the crypto asset system 100. On the transaction checking screen 144, information indicating a more detailed transaction history such as a transaction time, an address of a transferor of a crypto asset, an address of a transferee, a type of currency, and an amount of currency is displayed. These pieces of information are transmitted from the crypto asset system 100 to the terminal apparatus 102B. The information indicating the transaction history displayed on the transaction checking screen 144 corresponds to an example of information for checking payment, and the information displayed on the notification screen 142 corresponds to an example of guidance information for guiding the user B (the transferor of a crypto asset) to the transaction checking screen 144.

As described above, in a case where the user A performs payment by a crypto asset, the user B which has transferred the crypto asset to the user A is notified of information on the payment. Thus, the crypto asset can be appropriately used. Namely, the user B can recognize how the crypto asset is used by the user A who is the transferee of the crypto asset by referring to the notified information, and as a result, the user B can check whether the use is appropriate or not. Since the user B is notified of the information on the payment, the user B does not need to check the payment recorded in the ledger by a manual operation.

In a case where payment by the user A is not normally completed, information described below is displayed. In the crypto asset system 100, verification and approval of information on transaction by the user A is performed, and in a case where the user A does not have crypto asset for charge (for example, in a case where the amount of the crypto asset transferred by the user A from the user B is less than the charge for payment), as shown in FIG. 22, an error screen 146 is displayed on the UI section 128 of the multifunction peripheral 104A. The information on the error screen 146 is generated by the crypto asset system 100, and is transmitted from the crypto asset system 100 to the multifunction peripheral 104A, and the error screen 146 is displayed on the UI section 128. On the error screen 146, information indicating that payment cannot be completed because the amount of money is insufficient is displayed. In this case, the user A pays the charge by selecting another payment method or the like.

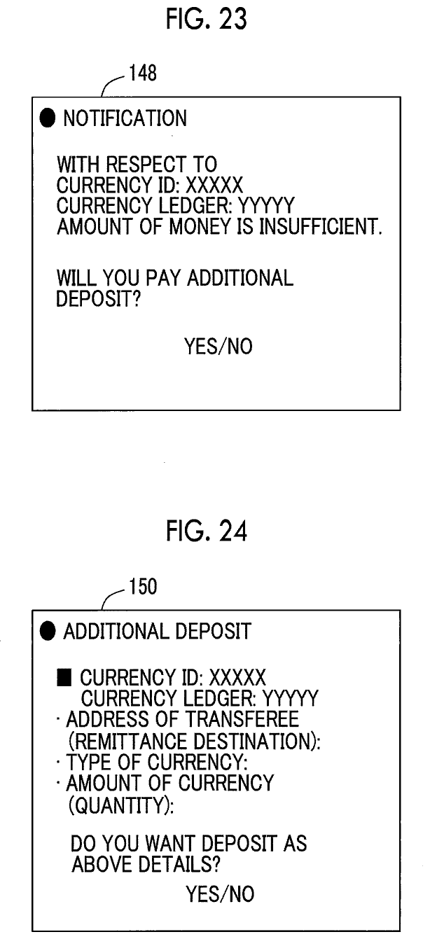

The notification section 112 transmits information indicating that the amount of money is insufficient to the terminal apparatus 102B used by the user B. As illustrated in FIG. 23, the control section 122 of the terminal apparatus 102B displays a notification screen 148 for notifying the user B of the information, on the UI section 120. The information on the notification screen 148 is generated by the crypto asset system 100. Information indicating that the crypto asset transferred to the user A by the user B is insufficient is displayed on the notification screen 148.

The user B can give an instruction to deposit additional crypto asset, on the notification screen 148. In a case where the user B gives an instruction to deposit additional crypto asset, on the notification screen 148, (for example, in a case where the user B presses a “yes” button), a deposit screen 150 is displayed on the UI section 120 of the terminal apparatus 102B, as shown in FIG. 24. On the deposit screen 150, an input field of a currency ID, an input field of a currency ledger, an input field of an address of a transferee (remittance destination), an input field of type of currency, an input field of amount of currency, or the like are displayed. In a case where the user B inputs information in these input fields and instructs remittance (for example, in a case where the user B presses the “yes” button), the crypto asset of the amount inputted here is remitted to the transferee (for example, the user A). Information on the transaction related to the remittance is transmitted from the terminal apparatus 102B to the crypto asset system 100, and a block including the transaction is formed in the crypto asset system 100.

In a case where the crypto asset owned by the user A is insufficient, the user B is notified of information indicating the fact, so the user B can recognize the shortage of the crypto asset. In a case where additional crypto asset is deposited, the user A can complete the payment.

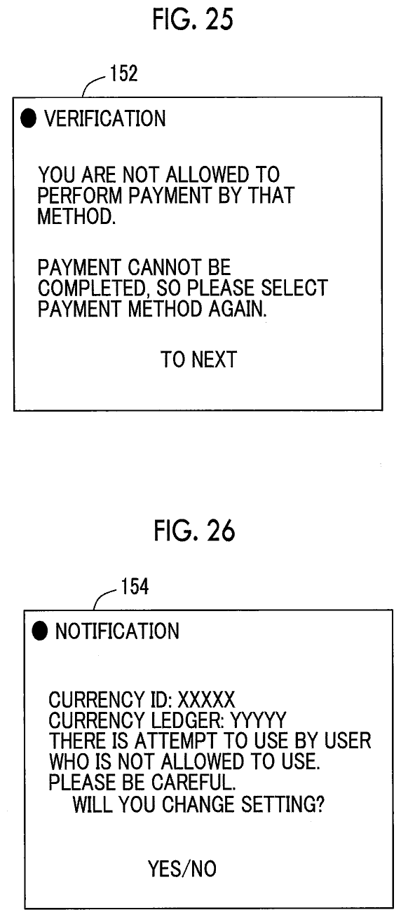

In a case where the user A is not allowed to perform payment by the crypto asset designated on the payment screen 138 (for example, payment by the crypto asset by user A is not allowed by the instruction from the user B, in a case where there is an attempt to perform payment by the crypto asset outside the time zone in which use is allowed, or in a case where an attempt to perform payment by the crypto asset is made by an apparatus other than the terminal apparatus allowed to use), as shown in FIG. 25, an error screen 152 is displayed on the UI section 128 of the multifunction peripheral 104A. The information on the error screen 152 is generated by the crypto asset system 100, and is transmitted from the crypto asset system 100 to the multifunction peripheral 104A, and the error screen 152 is displayed on the UI section 128. On the error screen 152, information indicating that the user A does not allow payment by the payment method selected by the user A is displayed. The user A pays the charge by selecting another payment method or the like.

The notification section 112 transmits to the terminal apparatus 102B used by the user B, information indicating that an attempt to use the crypto asset possessed by the user B has been made by a user who is not allowed to use. As illustrated in FIG. 26, the control section 122 of the terminal apparatus 102B displays a notification screen 154 for notifying the user B of the information, on the UI section 120. The information on the notification screen 154 is generated by the crypto asset system 100. On the notification screen 154, information indicating the ID of the crypto asset owned by the user B and the currency ledger, and information indicating that there is an attempt to use the crypto asset from a not-allowed user is displayed.

In a case where there is an attempt to use the crypto asset from a not-allowed user, the user B is notified of information indicating the fact, so the user B can recognize the situation.

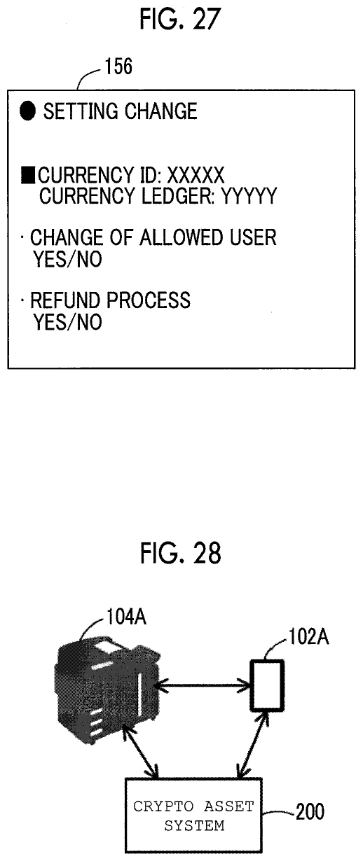

The user B can give an instruction to change setting about the use of the crypto asset, on the notification screen 154. In a case where the user B gives an instruction to change the setting, on the notification screen 154 (for example, in a case where the user B presses a “yes” button), a setting change screen 156 is displayed on the UI section 120 of the terminal apparatus 102B, as shown in FIG. 27. On the setting change screen 156, an input field of a currency ID, an input field of currency ledger, an instruction field for changing an allowed user, an instruction field for a refund process, or the like are displayed.

In a case where the user B inputs information on a currency ID and a currency ledger on the setting change screen 156 and instructs the change of allowed users (for example, in a case where the user B presses “Yes” button), the user allowed to use the crypto asset specified by the currency ID and the currency ledger is changed. For example, in a case where the user B inputs information for specifying the user allowed to use (for example, address information and account information) on the setting change screen 156 and instructs the change of allowed users, the user allowed to use is changed. Information indicating the user allowed to use the crypto asset is transmitted from the terminal apparatus 102B to the crypto asset system 100, and the information indicating the user is recorded in the block. Thus, the user is allowed to use the crypto asset.

In a case where the user B inputs information on a currency ID and a currency ledger on the setting change screen 156 and gives an instruction for refund processing (for example, in a case where the user B presses “Yes” button), the crypto asset specified by the currency ID and the currency ledger is refunded to the user B. For example, the crypto asset transferred by the user B to another user is refunded to the user B. Information on the transaction related to the refund is transmitted from the terminal apparatus 102B to the crypto asset system 100, and the information on the transaction is recorded in the block.

By refunding the crypto asset to the user B, the crypto asset can be prevented from being used by a not-allowed user.

The payment screen, the payment completion screen, the error screen, and the like are displayed on the UI section 120 of the terminal apparatus 102A owned by the user A, and information inputted on these screens, information on transaction, and the like may be transmitted from the terminal apparatus 102A to the crypto asset system 100. Information indicating that the transaction is performed may be transmitted from the terminal apparatus 102A or the multifunction peripheral 104A to the terminal apparatus 102B.

In the second exemplary embodiment, for example, the processing apparatus 106 operates as an example of the information processing apparatus.

The information processing apparatus according to the second exemplary embodiment includes a notification means that notifies a transferor of information on payment, in a case where a user who has received identification information of identity of a crypto asset from the transferor performs the payment using the crypto asset specified by the identification information. The notification is, for example, a notification of information shown in FIG. 20 and FIG. 21. The notification means is, for example, a notification section 112. Of course, the equipment 104 may be provided with the notification section 112. In this case, the equipment 104 corresponds to an example of the information processing apparatus. The identification information is, for example, a hash value recorded in the block.

In a case where payment is performed by the crypto asset specified by the identification information, the notification means may notify the transferor of guidance information for guiding the transferor to information for checking the payment (transaction information). The notification is, for example, a notification of information shown in FIG. 20 and FIG. 21. For example, information displayed on the transaction checking screen 144 shown in FIG. 21 corresponds to an example of information for checking the payment.

The notification means may also notify the transferor of information for remitting the crypto asset to the user in a case where the crypto asset specified by the identification information is insufficient. The notification is, for example, a notification of information shown in FIG. 23 and FIG. 24.

In a case where the user is not allowed to perform payment by the crypto asset specified by the identification information, the notification means may notify the transferor of information indicating the fact. The notification is, for example, a notification of information shown in FIG. 26.

The notification means may also notify the transferor of information for refunding the crypto asset specified by the identification information to the transferor. The notification is, for example, a notification of information shown in FIG. 27.

### Third Exemplary Embodiment

Hereinafter, an information processing system according to a third exemplary embodiment of the present invention will be described. The information processing system according to the third exemplary embodiment is to provide a technique for suppressing transactions using crypto asset with relatively low reliability.

Also in the third exemplary embodiment, as in the second exemplary embodiment, a crypto asset is managed by, for example, a distributed network using a block chain.

The information processing system according to the third exemplary embodiment will be described with reference to FIG. 28. FIG. 28 illustrates an example of the information processing system according to the third exemplary embodiment.

The information processing system according to the third exemplary embodiment includes a crypto asset system 200, one or plural terminal apparatuses, and one or plural pieces of equipment. In the example shown in FIG. 28, the information processing system includes a terminal apparatus 102A and equipment 104A. This configuration is only an example, and other terminal apparatuses and other equipment may be included in the information processing system. Hereinafter, in a case where it is not necessary to distinguish respective terminal apparatuses, the respective terminal apparatuses are referred to as “terminal apparatus 102”. Further, in a case where it is not necessary to distinguish respective equipment, respective equipment is referred to as “equipment 104”.

The crypto asset system 200, the terminal apparatus 102, and the equipment 104 each have a function of communicating with other apparatuses. The communication may be wireless communication or wired communication. The crypto asset system 200, the terminal apparatus 102, and the equipment 104 may communicate with other apparatuses through communication path such as the Internet or other networks, directly communicate with other apparatuses, or communicate with other apparatuses through a repeater.

The terminal apparatus 102 according to the third exemplary embodiment has the same configuration as that of the terminal apparatus 102 according to the second exemplary embodiment, and the equipment 104 according to the third exemplary embodiment has the same configuration as that of the equipment 104 according to the second exemplary embodiment. The terminal apparatus 102 and the equipment 104 can transmit and receive transaction information to and from the crypto asset system 200.

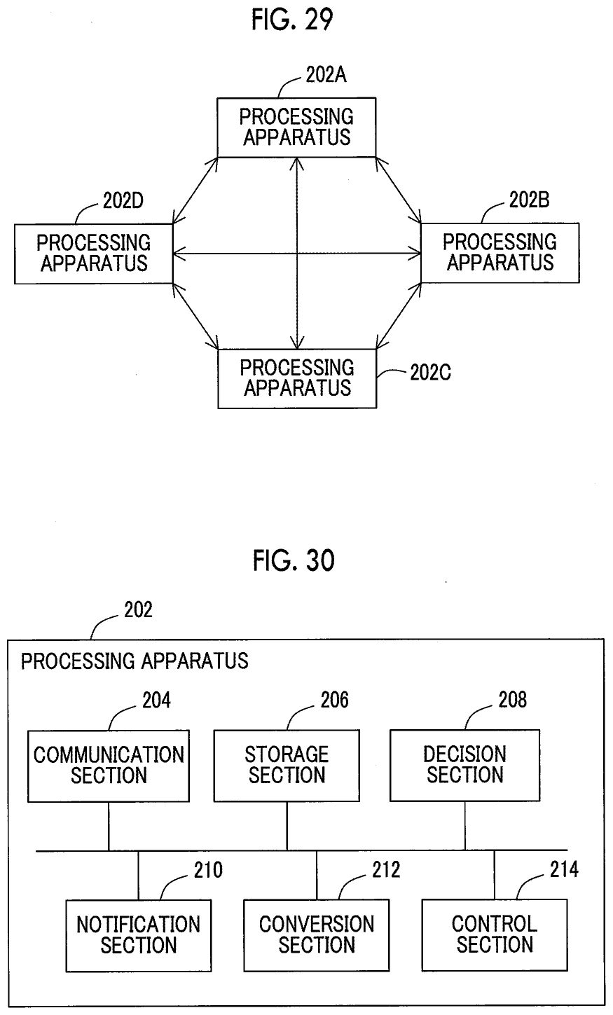

Hereinafter, the crypto asset system 200 will be described with reference to FIG. 29. FIG. 29 illustrates an example of the configuration of the crypto asset system 200. The crypto asset system 200 is a distributed network system including plural processing apparatuses (for example, processing apparatuses 202A, 202B, 202C, and 202D). Hereinafter, in a case where it is not necessary to distinguish respective processing apparatuses, the respective processing apparatuses are referred to as “processing apparatus 202”. Similarly to the crypto asset system 100 according to the second exemplary embodiment, the crypto asset system 200 has a configuration of a peer-to-peer (P2P) type in which plural processing apparatuses 202 communicate with each other, and respective processing apparatuses 202 are connected to each other to manage the same data. In the example shown in FIG. 29, although four processing apparatuses 202 are included in the crypto asset system 200, the number of processing apparatuses 202 is not limited thereto.

The processing apparatus 202 is, for example, an apparatus such as a PC, a tablet PC, a smartphone, or a mobile phone. Crypto asset management software is installed in the processing apparatus 202, and the processing apparatus 202 is an apparatus that performs transaction by using a crypto asset and verifies and approves the transaction information. In the examples shown in FIG. 28 and FIG. 29, the terminal apparatus 102 and the equipment 104 are not included in the crypto asset system 200, but the terminal apparatus 102 and the equipment 104 may also be included in the crypto asset system 200 to constitute the crypto asset system 200, similarly to the processing apparatus 202. Namely, the terminal apparatus 102 and the equipment 104 may also be connected to the other apparatus, similarly to the processing apparatus 202, and verifies or approves the transaction data.

A part of information handled by the crypto asset system 200 may be collected by a centralized apparatus (for example, a server), without being synchronized between apparatuses by P2P type communication.

Similarly to the second exemplary embodiment, account addresses are distributed to the terminal apparatus 102 and the processing apparatus 202, and the purchase and transaction of the crypto asset become possible. Information and history on the transaction of the crypto asset are distributed and managed as a block chain in the entire crypto asset system 200. Namely, as shown in FIG. 11, a block including plural pieces of transaction information of the crypto asset is successively connected to a block generated one before the block, and each of blocks connected in this manner is managed by each of the plural processing apparatuses 202.

Hereinafter, the configuration of the processing apparatus 202 will be described in detail with reference to FIG. 30. FIG. 30 illustrates an example of the configuration of the processing apparatus 202.

A communication section 204 is a communication interface, and has a function of transmitting data to other apparatuses and a function of receiving data from other apparatuses. The communication section 204 may be a communication interface having a wireless communication function or a communication interface having a wired communication function.

A storage section 206 is one or plural storage areas for storing various types of information. Each storage area may be defined as one or plural storage devices (physical drives) provided in the processing apparatus 202, or may be defined as a logical partition or a logical drive set in one or plural storage devices.

The storage section 206 stores, for example, currency management information. The currency management information is information for determining whether or not payment is possible by each crypto asset. For example, crypto asset which is not generally distributed, crypto asset which is unstable in a price and a rate, crypto asset that is likely to be used for crime, or the like corresponds to an example of crypto asset in which payment is impossible, and other crypto asset corresponds to an example of payable crypto asset.

A decision section 208 is configured to refer to currency management information and determine whether or not the crypto asset that the user intends to use for payment corresponds to a payable crypto asset.

The notification section 210 is configured to notify the terminal apparatus 102 used by the user and the equipment 104 on which payment is performed of information indicating a determination result by the decision section 208.

The conversion section 212 is configured to convert the crypto asset into another crypto asset in a case where the crypto asset that the user intends to use for payment corresponds to crypto asset which cannot be paid. Another crypto asset is a payable crypto asset. The conversion section 212 converts, for example, a crypto asset which cannot be paid into a crypto asset with a higher reliability. The conversion section 212 may convert the crypto asset which cannot be paid into legal currency (for example, yen, dollar, or the like). The conversion section 212 may convert the crypto asset into another crypto asset after receiving payment by the crypto asset which cannot be paid.

The control section 214 is configured to control the operation of each part of the processing apparatus 202. For example, since the storage section 206 stores crypto asset management software, and the control section 214 executes the crypto asset management software, transaction using the crypto asset, and verification and approval of transaction information are performed.

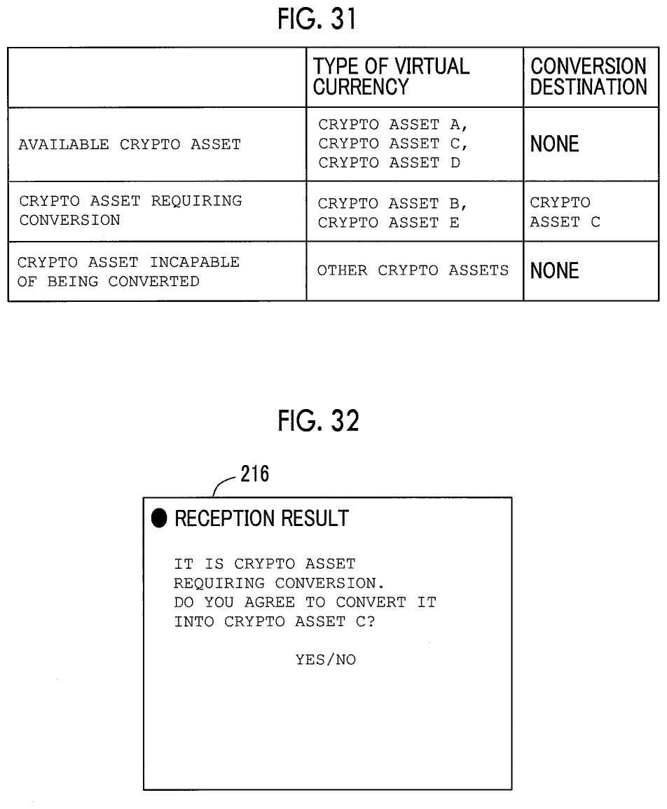

Hereinafter, an example of currency management information will be described with reference to FIG. 31. FIG. 31 illustrates an example of the currency management table as currency management information. In a currency management table, available crypto asset, crypto asset requiring conversion, and crypto asset incapable of being converted are registered.

Available crypto assets are the currencies that can be used. For example, a crypto asset which is relatively stable in a price and a rate, is generally distributed, and is less likely to be used for crime, that is, a crypto asset with a relatively high reliability corresponds to an example of an available crypto asset. For example, crypto assets A, C, and D are registered in the currency management table, as types of available crypto assets. Since these crypto assets can be used as they are, the crypto asset of the conversion destination is not registered.

The crypto asset requiring conversion is a currency which cannot be used as it is, but is allowed to be converted into another crypto asset. For example, a crypto asset which is unstable in a price and a rate, is generally distributed, and is less likely to be used for crime, that is, a crypto asset with relatively moderate reliability corresponds to an example of crypto asset requiring conversion. For example, crypto assets B, E are registered in the currency management table, as crypto assets requiring conversion. These crypto assets are currencies that cannot be used as they are, but are currencies that are allowed to be converted into a crypto asset C. In a case where the transaction is performed by the crypto assets B, E, the crypto assets B, E are converted into the crypto asset C and the transaction is performed.

In the example shown in FIG. 31, only one crypto asset (crypto asset C) is registered as the crypto asset of the conversion destination, but plural crypto assets may be registered as the crypto asset of the conversion destination. For example, plural prioritized crypto assets may be registered as the crypto asset of the conversion destination. In a case where a payment request for a crypto asset requiring conversion is given by a user, crypto assets of plural conversion destinations are presented to the user according to priority, and the crypto asset requiring conversion is converted into the crypto asset of the conversion destination selected by the user.

The crypto asset incapable of being converted is a currency which cannot be used as it is and is not allowed to be converted into another crypto asset. Here, the crypto asset which does not correspond to either the available crypto asset or the crypto asset requiring conversion corresponds to the crypto asset incapable of being converted. For example, a crypto asset which is not generally distributed, and has a high probability of being used for crime, that is, a crypto asset with a relatively low reliability corresponds to an example of crypto asset incapable of being converted. Since the crypto asset incapable of being converted is not allowed to be converted into another crypto asset, the crypto asset of the conversion destination is not registered.

Data of the currency management table is prepared in advance and stored in the storage section 206 of the processing apparatus 202. For example, the reliability of each crypto asset is determined by a manager of the crypto asset system 200, and each crypto asset may be registered in a currency management table according to the determination result. The crypto asset of the conversion destination may be registered by a manager or the like.

The decision section 208 of the processing apparatus 202 may collect information on each crypto asset by using the Internet, or the like, determine the reliability of each crypto asset based on the information, and update the currency management table based on the determination result. The decision section 208 may determine the reliability of the new crypto asset, and register the new crypto asset in a currency management table as a crypto asset belonging to any one of the available crypto asset, the crypto asset requiring conversion, and the crypto asset incapable of being converted.

For example, the decision section 208 may predict the possibility of each crypto asset receiving 51% attack, based on the cost required for so-called 51% attack for each crypto asset, and may determine the reliability of each crypto asset. The lower the cost, the higher the possibility of receiving 51% attack. For example, a crypto asset having a relatively low possibility of receiving 51% attack (for example, a crypto asset whose probability of receiving 51% attack is a lower threshold (for example, 10%) or less) is determined to be a crypto asset with relatively high reliability. A crypto asset having a relatively moderate possibility of receiving 51% attack (for example, a crypto asset whose probability of receiving 51% attack exceeds a lower threshold and is an upper threshold (40%) or less) is determined to be a crypto asset with relatively moderate reliability. A crypto asset having a relatively high possibility of receiving 51% attack (for example, a crypto asset whose probability of receiving 51% attack exceeds an upper threshold) is determined to be a crypto asset with relatively low reliability.

The decision section 208 may also predict the possibility of each crypto asset being attacked by 51%, based on the share of the mining pool of each crypto asset. For example, since a crypto asset whose share of a single company is 51% or more is a currency having a relatively high possibility of receiving 51% attack, the crypto asset is determined to be a crypto asset with relatively low reliability. Since a crypto asset whose total share of two or three companies is 51% or more is a currency having a relatively moderate possibility of receiving 51% attack, the crypto asset is determined to be a crypto asset with relatively moderate reliability. It is because there is a possibility that two or three companies join and perform 51% attack.

The decision section 208 may determine the reliability of each crypto asset, based on the number of issued crypto assets. The smaller the number of issued crypto asset, the smaller the data amount of the block chain is, and the easier data is tampered with, so it is determined that such crypto asset is less reliable crypto asset. For example, a threshold of the number of issued crypto assets is determined, and the decision section 208 determines the reliability of each crypto asset, based on the comparison of the number of issued crypto assets with the threshold.

There are also crypto assets that do not require mining. The risk of hacking into such a crypto asset is considered lower than the risk of hacking into a crypto asset requiring mining. Accordingly, the crypto asset which does not require mining may be determined to be the crypto asset with higher reliability than the crypto asset requiring mining.

Each of the above determination elements (cost required for 51% attack, share of mining pool, number of issued sheets, necessity of mining) is only an example of determination element (currency risk factors) for determining the reliability of crypto asset, the decision section 208 may determine the reliability of crypto asset based on other determination elements. The decision section 208 may comprehensively determine each of the determination elements, and determine the reliability of each crypto asset. For example, the decision section 208 determines the reliability of each crypto asset by applying a weighting process to each determination element. Since the share of the mining pool or the like is changed at any time, the decision section 208 may collect such information at any time to determine the reliability of the crypto asset.

The decision section 208 may determine the priority of the crypto asset of the conversion destination, based on the price variation of each crypto asset. For example, the decision section 208 determines the crypto asset whose price drop probability is higher, as the crypto asset of the conversion destination whose priority is lower, based on the history of the past price variation of each crypto asset. On the other hand, the decision section 208 determines the crypto asset whose price tends to rise, and which is higher in rise, as the crypto asset of the conversion destination whose priority is higher.

Conversion fee may be charged for converting a crypto asset. The decision section 208 may determine the crypto asset with high conversion fee (concept including transaction costs such as spread) as the crypto asset of the conversion destination whose priority is lower.

The decision section 208 may determine the reliability of each crypto asset, based on the market capitalization value of each crypto asset, or may determine the crypto asset of the change destination. For example, the crypto asset whose market capitalization value is the threshold or more is determined to be the crypto asset whose reliability is relatively high. The crypto asset whose market capitalization value is less than the threshold is determined to be the crypto asset whose reliability is relatively moderate. The crypto asset whose market capitalization value is the threshold or more may be registered as the crypto asset of the conversion destination, and the crypto asset whose market capitalization value is less than the threshold may not be registered as the crypto asset of the conversion destination. The crypto asset with low market capitalization value is considered to be crypto asset with low reliability because it is susceptible to buying and selling.

The decision section 208 may determine the reliability of each crypto asset, based on the remittance speed of each crypto asset. For example, the crypto asset whose remittance speed is fast and transaction delay does not occur is determined to be crypto asset with relatively high reliability. The crypto asset with less rate variation may be determined to be crypto asset with relatively high reliability.

The decision section 208, the notification section 210, and the conversion section 212 may be provided in the terminal apparatus 102 or the equipment 104, and processing by these sections may be executed by the terminal apparatus 102 or the equipment 104. The respective processes may be distributedly performed by the terminal apparatus 102, the equipment 104, and the crypto asset system 200.

Hereinafter, the operation of the information processing system according to the third exemplary embodiment will be described with a specific example. Here, the user A uses the multifunction peripheral 104A, and performs payment by the crypto asset for the use.

First, the user A logs in the multifunction peripheral 104A. As in the second exemplary embodiment, as shown in FIG. 16, a login screen 134 is displayed on the UI section 128 of the multifunction peripheral 104A, and the user A logs in the multifunction peripheral 104A by inputting a user ID and a password associated with the user A, on the login screen 134. The user ID and the password are transmitted from the multifunction peripheral 104A to the crypto asset system 200. Thus, in the crypto asset system 200, the user A logging in to the multifunction peripheral 104A is specified. The multifunction peripheral 104A acquires identification information for identifying the terminal apparatus 102A, address information, or the like, by communicating with the terminal apparatus 102A used by the user A, and transmits the information to the crypto asset system 200. Further, the multifunction peripheral 104A transmits information for identifying a store where the multifunction peripheral 104A is installed, information for identifying equipment on which the user A performs payment (for example, the multifunction peripheral 104A), and information for identifying a service used by the user (for example, a service used by the user A on the multifunction peripheral 104A) to the crypto asset system 200. Thus, in the crypto asset system 200, the store, the equipment (for example, the multifunction peripheral 104A), and the service are specified. In a case where the user A purchases products or services at an actual store, information for identifying the actual store is transmitted to the crypto asset system 200, but in a case where the user A purchases products or services at a shopping site, information for identifying the shopping site is transmitted to the crypto asset system 200.

After the user A uses the service provided by the multifunction peripheral 104A, payment for the use is charged. Similarly to the second exemplary embodiment, as shown in FIG. 17, a payment screen 136 is displayed on the UI section 128 of the multifunction peripheral 104A. On the payment screen 136, information indicating a payment method payable on the multifunction peripheral 104A is displayed. Here, since payment by cash, electronic money, and crypto asset is possible, information indicating this fact is displayed.

In a case where the user A selects payment by a crypto asset on the payment screen 136, similarly to the second exemplary embodiment, as shown in FIG. 18, a payment screen 138 for inputting information about the crypto asset is displayed on the UI section 128 of the multifunction peripheral 104A, as shown in FIG. 18. For example, on the payment screen 138, the user A inputs an ID for specifying a crypto asset used for payment and information for specifying a ledger (block chain) of the crypto asset. The user A using the crypto asset is specified, based on the information inputted at the time of login, the crypto asset ID, and the ledger information.

In a case where the user A instructs payment on the payment screen 138 (for example, a case where a “next” button is pressed by the user A), information on transaction performed by the multifunction peripheral 104A is transmitted from the multifunction peripheral 104A to the crypto asset system 200. For example, information on transactions including information inputted at the time of login, a crypto asset ID and ledger information is transmitted from the multifunction peripheral 104A to the crypto asset system 100.

In the crypto asset system 200, the transaction information is verified and approved. In the third exemplary embodiment, the decision section 208 of the processing apparatus 202 determines whether or not the crypto asset having been attempted to be paid by the user A corresponds to the available crypto asset, based on the information transmitted from the multifunction peripheral 104A. As an example, the currency management table shown in FIG. 31 is used for the determination.

For example, the user A attempts to perform payment by using the crypto asset A. Since the crypto asset A is crypto asset with relatively high reliability, it is used for payment as it is and normally paid.

In a case where the payment is normally completed, similarly to the second exemplary embodiment, a payment completion screen 140 is displayed on the UI section 128 of the multifunction peripheral 104A, as shown in FIG. 19. The payment completion screen 140 is generated by the crypto asset system 200, and information on the payment completion screen 140 is transmitted from the crypto asset system 200 to the multifunction peripheral 104A, and the payment completion screen 140 is displayed on the UI section 128. Similarly to the second exemplary embodiment, payment notification is transmitted to a predetermined destination (for example, the terminal apparatus 102 used by the user who has transferred the crypto asset A to the user A), and information indicating the fact may be displayed.

The user A attempts to perform payment by using the crypto asset B instead of the crypto asset A. Since the crypto asset B is crypto asset with relatively moderate reliability, it is not used for payment as it is. On the other hand, the crypto asset B is a crypto asset whose change is allowed to the usable crypto asset C. In this case, the notification section 210 transmits information indicating that the crypto asset B is a crypto asset requiring conversion, to the multifunction peripheral 104A. The information is displayed in the UI section 128 of the multifunction peripheral 104A.

For example, as shown in FIG. 32, a notification screen 216 is displayed on the UI section 128 of the multifunction peripheral 104A. On the notification screen 216, information indicating that the crypto asset B is a crypto asset requiring conversion and information for urging the user A to convert the crypto asset B into the crypto asset C are displayed.

In the user A instructs conversion of a crypto asset on the notification screen 216 (for example, in a case where the user A presses a “yes” button), information indicating the instruction is transmitted from the multifunction peripheral 104A to the crypto asset system 200. In the crypto asset system 200, the conversion section 212 converts the crypto asset B into the crypto asset C according to the instruction. In a case where a fee is required for the conversion, the fee is paid by the user A or the side receiving the payment (for example, the company or the like). Then, payment is performed by the converted crypto asset C.

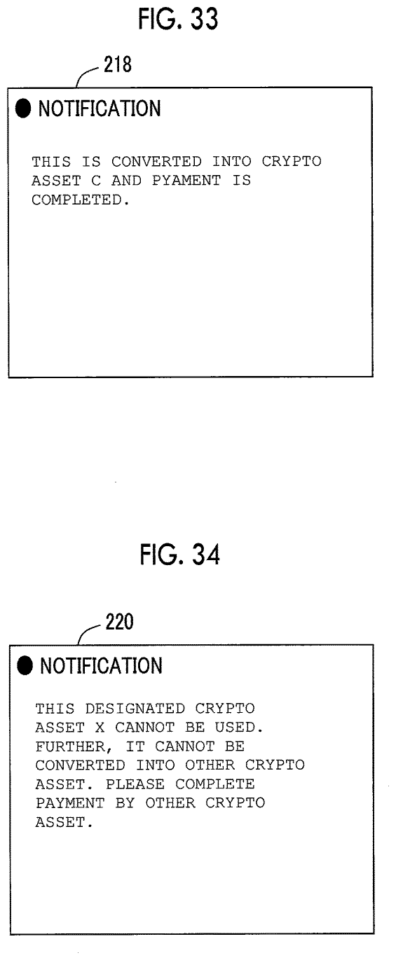

In a case where the payment by the crypto asset C is normally completed, a payment completion screen 218 is displayed on the UI section 128 of the multifunction peripheral 104A, as shown in FIG. 33. The payment completion screen 218 is generated by the crypto asset system 200, and information on the payment completion screen 218 is transmitted from the crypto asset system 200 to the multifunction peripheral 104A, and the payment completion screen 218 is displayed on the UI section 128. On the payment completion screen 218, information indicating that the crypto asset B is converted into the crypto asset C and payment is completed by the crypto asset C is displayed.

Even in a case where the conversion instruction by the user A is not given, the conversion section 212 may automatically convert the crypto asset B into the crypto asset C. Then, payment is performed by the converted crypto asset C. In this case, the notification screen 216 may not be displayed on the UI section 128 of the multifunction peripheral 104A, and the payment completion screen 218 may be displayed on the UI section 128. For example, in a case where setting to execute payment following automatic conversion of crypto asset is made in advance by the user A, the conversion section 212 automatically converts the crypto asset B into the crypto asset C.

The user A attempts to perform payment by using the crypto asset X instead of the crypto asset A and B. The crypto asset X is a crypto asset which does not correspond to either the available crypto asset or the crypto asset requiring conversion, and is the crypto asset incapable of being converted. Namely, the crypto asset X is a crypto asset with relatively low reliability. In this case, the notification section 210 transmits information indicating that the crypto asset X cannot be used and converted into another crypto asset, to the multifunction peripheral 104A. The information is displayed in the UI section 128 of the multifunction peripheral 104A.

For example, as shown in FIG. 34, a notification screen 220 is displayed on the UI section 128 of the multifunction peripheral 104A. On the notification screen 220, information indicating that the crypto asset X cannot be used and converted into another crypto asset is displayed. The user A performs payment by another payment method.

The payment screen, the payment completion screen, the notification screen, and the like are displayed on the UI section 120 of the terminal apparatus 102A owned by the user A, and information inputted on these screens, information on transaction, and the like may be transmitted from the terminal apparatus 102A to the crypto asset system 200.

As described above, in a case where an attempt to pay a crypto asset with relatively low reliability is made, payment by the crypto asset is not performed, so a transaction using the crypto asset with relatively low reliability can be suppressed.

The crypto asset with relatively moderate reliability is converted into another crypto asset with relatively high reliability, and payment is made by the converted crypto asset, so transaction can be performed by the crypto asset with relatively high reliability.

In the third exemplary embodiment, for example, the processing apparatus 202 operates as an example of the information processing apparatus.

The information processing apparatus according to the third exemplary embodiment includes a determination means that determines whether or not payment by the crypto asset is possible, for example, in a case of payment by the crypto asset is received. A determination means is, for example, a decision section 208. Of course, the terminal apparatus 102 and the equipment 104 may be provided with the decision section 208. In this case, the terminal apparatus 102 and the equipment 104 correspond to an example of the information processing apparatus.

The information processing apparatus according to the third exemplary embodiment includes a notification means that notifies the user of information indicating whether or not payment by the crypto asset is possible, for example, in a case of payment by the crypto asset is received. A notification means is, for example, the notification section 210. Of course, the terminal apparatus 102 and the equipment 104 may be provided with the notification section 210. In this case, the terminal apparatus 102 and the equipment 104 correspond to an example of the information processing apparatus.

The information processing apparatus according to the third exemplary embodiment may further include a conversion means that converts the crypto asset into another crypto asset in a case where payment by the crypto asset is impossible. A conversion means is, for example, the conversion section 212. Of course, the terminal apparatus 102 and the equipment 104 may be provided with the conversion section 212. In this case, the terminal apparatus 102 and the equipment 104 correspond to an example of the information processing apparatus.

In a case where payment by the crypto asset is impossible, the notification means may notify the user of information indicating that the crypto asset is converted into another crypto asset.

The above apparatuses (the server 10, the terminal apparatuses 12, 102, the equipment 14, 104, and the processing apparatuses 106, 202) are realized by, for example, cooperation of hardware and software. Specifically, each apparatus is provided with one or plural processors such as a CPU (not shown). The functions of the respective sections of the respective apparatuses are realized by the one or plural processors reading and executing the program stored in the storage device (not shown). The program is stored in a storage device through a recording medium such as a CD or a DVD or through a communication path such as a network. As another example, each portion of each apparatus may be realized by hardware resources such as a processor, an electronic circuit or an application specific integrated circuit (ASIC). A device such as a memory may be utilized for the realization. In another example, each portion of each apparatus may be realized by a digital signal processor (DSP) or a field programmable gate array (FPGA).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reception unit that receives payment by a recommended payment method determined according to a determination criterion for determining the recommended payment method from among one or a plurality of payment methods payable by a user, in a case of receiving a payment request from the user.

2. The information processing apparatus according to claim 1, further comprising:
a control unit that controls notification of the recommended payment method to the user, before the reception unit receives payment.

3. The information processing apparatus according to claim 2,
wherein in a case of receiving notification of determination of the recommended payment method from the user who receives the notification of the recommended payment method, the reception unit receives the payment.

4. The information processing apparatus according to claim 1,
wherein the reception unit has a function of receiving payment by a payment method selected from among the plurality of payment methods.

5. The information processing apparatus according to claim 2,
wherein the reception unit has a function of receiving payment by a payment method selected from among the plurality of payment methods.

6. The information processing apparatus according to claim 3,
wherein the reception unit has a function of receiving payment by a payment method selected from among the plurality of payment methods.

7. The information processing apparatus according to claim 1,
wherein each payment method differs for each provider which provides a payment method.

8. The information processing apparatus according to claim 2,
wherein each payment method differs for each provider which provides a payment method.

9. The information processing apparatus according to claim 3,
wherein each payment method differs for each provider which provides a payment method.

10. The information processing apparatus according to claim 4,
wherein each payment method differs for each provider which provides a payment method.

11. The information processing apparatus according to claim 1,
wherein in each payment method, a benefit to be given to the user varies depending on payment.

12. The information processing apparatus according to claim 1,
wherein the determination criterion can be changed by the user.

13. The information processing apparatus according to claim 12, further comprising:
a setting unit that sets the determination criterion based on one or a plurality of determination elements designated by the user,
wherein each determination element relates to a benefit to be given to the user in a case where payment is performed.

14. The information processing apparatus according to claim 13,
wherein the setting unit determines the determination criterion by applying a weighting process to the plurality of determination elements.

15. The information processing apparatus according to claim 13,
wherein the determination element is a rate of a point to be obtained at a time of payment, an expiration date of the point, versatility of the point, a conversion rate when the point is converted to other points, or a discount rate.

16. The information processing apparatus according to claim 13,
wherein the setting unit determines the determination criterion, based on the one or plurality of determination elements at the time when the reception unit receives the payment request.

17. The information processing apparatus according to claim 13,
wherein the setting unit changes the determination element designated by the user to another determination element to determine the determination criterion, based on a purchase history of the user.

18. The information processing apparatus according to claim 1,
wherein in a case where a payment method in which a remaining valid period is a threshold or less is included in the one or plurality of payment methods payable by the user, the reception unit receives payment by the payment method in which the remaining valid period is the threshold or less as the recommended payment method.

19. The information processing apparatus according to claim 1, further comprising:
a control unit that receives a purchase object purchased by the user and performs control so as to notify the user of the recommended payment method, based on a price of the purchase object and the determination criterion.

20. A non-transitory computer readable medium storing a program causing a computer to function as:
a reception unit that receives payment by a recommended payment method determined according to a determination criterion for determining the recommended payment method from among one or a plurality of payment methods payable by a user, in a case of receiving a payment request from the user.
